(19) United States
(12) Patent Application Publication
(10) Pub. No.: US 2019/0269246 A1
(43) Pub. Date: Sep. 5, 2019

(54) ILLUMINATED INFLATABLE OBJECT

(71) Applicant: Youngblood IP Holdings, LLC, Mooresville, NC (US)

(72) Inventors: Todd Youngblood, Mooresville, NC (US); Tara Youngblood, Mooresville, NC (US)

(73) Assignee: Youngblood IP Holdings, LLC, Mooresville, NC (US)

(21) Appl. No.: 15/912,062

(22) Filed: Mar. 5, 2018

(51) Int. Cl. A47C 4/54; F21S 9/03; F21V 33/00

(52) U.S. Cl. CPC A47C 4/54; A63H 23/10; F21V 33/008; F21S 9/037

(57) ABSTRACT

An illuminated inflatable object formed of at least two pieces of material that define at least one interior chamber, at least one valve for delivering a fluid to and removing a fluid from the at least one interior chamber, at least one rechargeable battery disposed in the at least one interior chamber, at least one solar panel disposed in the at least one interior chamber and electrically connected to one or more of the at least one rechargeable battery, and at least one lighting source disposed in one or more of the at least one interior chamber.

### BACKGROUND OF THE INVENTION

### 1. Field of the Invention

This invention relates broadly and generally to illuminated inflatable objects, and more specifically to illuminated inflatable objects powered by an internal solar panel.

### 2. Description of the Prior Art

Inflatable objects (e.g., beach balls, pool floats) are often used for recreation purposes. Some of these inflatable objects include a lighting source, such as a light emitting diode (LED).

Prior art patent documents include the following:

U.S. Pat. No. 4,776,589 for lighted inflatable ball by inventor Yang, filed Jan. 28, 1987 and issued Oct. 11, 1988, is directed to a novel lighted inflatable ball having a novel structural design to enable the inflatable ball to be lighted at night for recreation. A hollow compartment of soft PVC membrane is centrally provided in an inflatable ball. One end of the hollow compartment is closed and the other end closable by a closure. A battery cell holder with switch is insertable in the hollow compartment. Wiring from the cell holder passes through the soft membrane layer by means of a blockading member in which the wiring is airtightly fused. The cell wiring is connected to bulb wiring of a plurality of bulbs fixed in projecting rings molded on outer sides of the hollow compartment.

U.S. Pat. No. 5,888,156 for lighted inflatable device by inventors Cmiel et al., filed Jun. 16, 1997 and issued Mar. 30, 1999, is directed to a lighted, inflatable device comprising a substantially sealed outer shell, an inner inflatable bladder disposed within the outer shell, a valve for inflating the inner inflatable bladder, and an illumination element disposed within the inner inflatable bladder. The illumination element includes a resistor for conserving battery life. The bladder and shell have translucent portions through which light from the illumination element passes.

U.S. Pat. No. 7,025,418 for positionable floating chair by inventor Hackal, filed Jul. 1, 2005 and issued Apr. 11, 2006, is directed to a floating chair including a buoyant member attached to a seat member (“seat”) for maintaining the seat above water. A maneuvering device is operatively attached to the seat. A battery and a CPU are in communication with the maneuvering device. A solar panel is in communication with the CPU for conveying sun location data to the CPU, and the solar panel may be electrically connected to the battery for charging the battery with solar energy. The CPU may determine the position of the seat relative to the sun or a remote object and actuate the maneuvering device to maintain the seat in a constant position relative to either. Further, the CPU may actuate the maneuvering device to move the seat in a clockwise direction, a counterclockwise direction, or laterally. When the floating chair is not in use, the seat may be moved from a lounging configuration to a storage configuration.

U.S. Publication No. 20060291217 for lighted inflated or inflatable objects by inventor Vanderschuit, filed Jul. 14, 2006 and published Dec. 28, 2006, is directed to an inflated or inflatable object generally including at least one light source for illuminating at least a portion of the inflated or inflatable object. The inflated or inflatable object may be a balloon, a ball, a lamp, a furniture piece, a raft, a pillow, a slide, a bouncing platform (e.g., bounce house, etc.), a swimming pool, a support for a body part, etc. In various embodiments, at least a portion of an inflated or inflatable object's skin is black-light sensitive, and at least one light source emits black light so as to illuminate the black-light sensitive portion of the skin. Other aspects of the present disclosure relate generally to methods relating to using, assembling, disassembling, and/or making lighted inflated or inflatable objects. Further aspects of the present disclosure relate to kits including components capable of being assembled into a lighted inflated or inflatable object. Additional aspects relate to methods that generally include receiving such a kit, and assembling the components within the kit into a lighted inflated or inflatable object.

U.S. Pat. No. 7,520,633 for lighting and display apparatus by inventors Hornsby et al., filed Jan. 6, 2006 and issued Apr. 21, 2009, is directed to a lighting system, apparatus and method that can be integrated into an office or household item. The lighting system has one or more light modules, each comprising three lights of a different color. The light modules further have a cover component having a hole positioned above the lights. The lighting system may further have a cushioned layer coupled to the light modules. The light modules are coupled to a power source and an integrated circuit, wherein the integrated circuit is configured to operate the light modules.

U.S. Pat. No. 9,016,886 for inflatable solar powered lamp by inventor Snyder, filed May 1, 2014 and issued Apr. 28, 2015, is directed to a solar powered lamp with flat ends and a translucent flexible housing, such that the housing can be inflated to form a free standing cylinder. A solar panel faces outward on one of the flat ends for recharging a low-profile rechargeable battery which, under the control of a printed circuit panel, powers an array of LEDs, which point into the lamp housing. Reflective surfaces, facing each other on opposite inside end walls of the lamp, maximize the diffusion of light from the LEDs. The lamp is a durable, portable, long light lighting solution for those who live off the electric power grid, victims of disaster, and the like.

U.S. Publication No. 20150327644 for leisure, recreational and home-use streaming apparatus by inventor Magnus, filed Jul. 27, 2015 and published Nov. 19, 2015, is directed to a leisure apparatus comprising a body having a volume that is able to contain articles for storage therein and for removal therefrom, or that defines an internal space that is able to seal therein a gas, liquid or solid. An output device is arranged externally at the body. A receiver is located behind a wall of the body to be separated from articles stored in and removed from the body, or is located and sealed within the internal space of the body. The receiver is adapted for receiving an electronic signal transmitted wirelessly from a proximate device and for communicating that signal to the output device.

U.S. Pat. No. 9,206,952 for solar-powered light source by inventors Gold et al., filed Mar. 15, 2013 and issued Dec. 8, 2015, is directed to a solar-powered light source that may comprise a solar-powered energy production module. The solar-powered light source may be self-righting. At least one of the energy production module, an energy storage module, a light emission device, or a diffuser may provide the weight for the self-righting effect. The weight may be located substantially near a bottom portion of the solar-powered light source in order to keep the solar-powered light source positioned upright.

U.S. Pat. No. 9,347,629 for inflatable solar-powered light by inventors Stork et al., filed Oct. 25, 2012 and issued May 24, 2016, is directed to an inflatable solar-powered light. In some embodiments, the inflatable solar-powered light includes the following: an expandable bladder including a plurality of surfaces; a solar-powered light assembly positioned on at least one of the plurality of surfaces of the bladder; and one or more cover portions positioned over the assembly and joined with the at least one of the plurality of surfaces of the bladder around its edges, wherein at least a portion of at least one of the at least one or more cover portions is substantially transparent and each of the one or more cover portions forms a substantially waterproof envelope with the at least one of the plurality of surfaces of the bladder in which the solar-powered light assembly is contained.

U.S. Pat. No. 9,533,197 for illuminated ball by inventor Larson, filed Feb. 22, 2016 and issued Jan. 3, 2017, is directed to an illuminated ball that may be used to play games in the water. An illuminated ball may include a hollow, spherical shell. A translucent light housing may be coupled to the shell. A light emitting device may be within the translucent housing. A battery housing coupled to the light emitting device. At least one battery may be within the battery housing. A circuit board may be coupled to the battery housing. Four conductors may be coupled to the circuit board, wherein two of the four conductors are coupled to the light emitting device and another two of the four conductors are coupled to at least two water contacts. The at least two water contacts are located on an outside of the illuminated ball, wherein on exposure to water, the at least two water contacts are electrically connected causing the light emitting device to emit light.

U.S. Publication No. 20170007934 for water toy by inventors Hohns et al., filed Sep. 26, 2016 and published Jan. 12, 2017, is directed to water toys and methods of attaching and detaching different types of upwardly protruding objects on the toy with a hydrofoil underneath comprising a skeg and a wing/vanes. The assembled toy can ride incoming waves back to shore. The hydrofoil can have weights being extra weight or thickened portions at any location on the wing vanes, skegs, any combination, or have no extra weight. The wings/vanes can be bendable to different positions to enhance the toy's performance. Different versions of pegs can be used to attach the main wing, skeg, flotation device and upwardly protruding objects together. The upwardly protruding objects can include figurines, vehicles, toys, sails and the like, and the toy can be used without an upwardly protruding object. The toy can also be pulled through the water with motorboats and/or fishing poles.

U.S. Publication No. 20170067268 for lighted inflatable apparatus by inventors Tong et al., filed Sep. 7, 2016 and published Mar. 9, 2017, is directed to a lighted inflatable pool including: a wall including a first inflatable chamber; a base; at least one lighting element disposed within the wall, the at least one lighting element being configured to emit light; and a receiver connected to the at least one lighting element, the receiver being configured to receive a command for controlling the lighting element and to control the at least one lighting element in correspondence with the command.

U.S. Pat. No. 9,630,687 for collapsible flotation device by inventors Le Gette et al., filed Feb. 21, 2014 and issued Apr. 25, 2017, is directed to a collapsible flotation device that uses a coilable spring coupled to a panel to collapse the device when the spring is coiled, and to expand the device when the spring is uncoiled configuration. The spring can be contained within a sleeve along the outer portion of the panel. A support member that traverses the panel is provided. An inflatable bladder disposed about a part of the outer portion of the panel and coupled to the support member buoyantly supports a body weight of a user. The combination of the inflatable bladder and the support member provide support for a user in a seated position on the panel. Many configurations are disclosed, including a multi-user collapsible flotation device, multiple connected single-user flotation devices, and so forth. A back support member and a headrest, both of which can be inflatable, provide additional support for a user to maintain a seated position on the panel. A foot support member is provided for the comfort of the user.

### SUMMARY OF THE INVENTION

The present invention relates to articles, methods, and systems for illuminated inflatable objects, and more specifically to illuminated inflatable objects powered by an internal solar panel.

In one embodiment, the present invention provides an illuminated inflatable object formed of at least two pieces of material, wherein each of the at least two pieces of material has an exterior surface and an interior surface, wherein each of the at least two pieces of material is permanently affixed to at least one other piece of material of the at least two pieces of material, and wherein the at least two pieces of material define at least one interior chamber, at least one valve for delivering a fluid to and removing the fluid from the at least one interior chamber, at least one rechargeable battery, wherein the at least one rechargeable battery is disposed in one or more of the at least one interior chamber, at least one solar panel electrically connected to one or more of the at least one rechargeable battery, wherein the at least one solar panel is disposed in one or more of the at least one interior chamber, at least one lighting source, wherein the at least one interior chamber is constructed and configured to retain the fluid, wherein the at least one rechargeable battery is operable to power one or more of the at least one lighting source, and wherein the at least one solar panel is operable to recharge one or more of the at least one rechargeable battery.

In another embodiment, the present invention provides an illuminated inflatable object formed of at least two pieces of material, wherein each of the at least two pieces of material has an exterior surface and an interior surface, wherein each of the at least two pieces of material is permanently affixed to at least one other piece of material of the at least two pieces of material, and wherein the at least two pieces of material define at least one interior chamber, at least one valve for delivering a fluid to and removing the fluid from the at least one interior chamber, at least one rechargeable battery, wherein the at least one rechargeable battery is disposed in one or more of the at least one interior chamber, at least one solar panel electrically connected to one or more of the at least one rechargeable battery, wherein the at least one solar panel is disposed in one or more of the at least one interior chamber, at least one lighting source, wherein the at least one lighting source is disposed in one or more of the at least one interior chamber, at least one antenna, wherein the at least one antenna is disposed in one or more of at least one interior chamber, wherein the at least one interior chamber is constructed and configured to retain the fluid, wherein the interior surface of each of the at least two pieces of material is comprised of at least one layer of a waterproof material, wherein the at least one rechargeable battery is operable to power one or more of the at least one lighting source, wherein the at least one solar panel is operable to recharge one or more of the at least one rechargeable battery, and wherein the illuminated inflatable object is operable to receive input data from at least one remote device via the at least one antenna.

In yet another embodiment, the present invention provides an illuminated inflatable chair formed of at least two pieces of material, wherein each of the at least two pieces of material has an exterior surface and an interior surface, wherein each of the at least two pieces of material is permanently affixed to at least one other piece of material of the at least two pieces of material, wherein the at least two pieces of material define at least one interior chamber, wherein the at least two pieces of material define a seat part and a back part, at least one valve for delivering a fluid to and removing the fluid from the at least one interior chamber, at least one rechargeable battery, wherein the at least one rechargeable battery is disposed in one or more of the at least one interior chamber, at least one solar panel electrically connected to one or more of the at least one rechargeable battery, wherein the at least one solar panel is disposed in one or more of the at least one interior chamber, at least one lighting source, wherein the at least one lighting source is disposed in one or more of the at least one interior chamber, and at least one antenna, wherein the at least one antenna is disposed in one or more of at least one interior chamber, wherein the at least one interior chamber is constructed and configured to retain the fluid, wherein the interior surface of each of the at least two pieces of material is comprised of at least one layer of a waterproof material, wherein the at least one rechargeable battery is operable to power one or more of the at least one lighting source, wherein the at least one solar panel is operable to recharge one or more of the at least one rechargeable battery, and wherein the illuminated inflatable chair is operable to receive input data from at least one remote device via the at least one antenna.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A illustrates an exploded view of one embodiment of an illuminated inflatable object.

FIG. 1B illustrates an exploded view of another embodiment of an illuminated inflatable object.

FIG. 2 illustrates a front perspective view of one embodiment of an illuminated inflatable chair in an illuminated state.

FIG. 3 illustrates a front perspective view of the illuminated inflatable chair of FIG. 2, including internal components.

FIG. 4 illustrates a front perspective view of another embodiment of an illuminated inflatable chair.

FIG. 5 illustrates a side perspective view of the embodiment of an illuminated inflatable chair shown in FIG. 2.

FIG. 6 illustrates a back perspective view of the embodiment of an illuminated inflatable chair shown in FIG. 2.

FIG. 7 illustrates one embodiment of an electronic compartment.

FIG. 8 illustrates one embodiment of a valve.

FIG. 9A illustrates another embodiment of a valve.

FIG. 9B illustrates the process of inflating the valve of FIG. 9A.

FIG. 9C illustrates the valve of FIG. 9A in a sealed position.

FIG. 10A illustrates yet another embodiment of a valve.

FIG. 10B illustrates the process of inflating the valve of FIG. 10A.

FIG. 10C illustrates the valve of FIG. 10A in a sealed position.

FIG. 11 illustrates a side perspective view of an illuminated inflatable shell float.

FIG. 12 illustrates a back perspective view of the illuminated inflatable shell float in FIG. 11, including internal components.

FIG. 13 illustrates one embodiment of a user interface for a remote device.

FIG. 14 illustrates another embodiment of a user interface for a remote device.

FIG. 15 illustrates a schematic diagram of an embodiment of the invention illustrating a computer system having a network, a plurality of computing devices, a server, and a database.

### DETAILED DESCRIPTION

The present invention is generally directed to articles, methods, and systems for powering an illuminated inflatable object using at least one solar panel embedded within the illuminated inflatable object.

In one embodiment, the present invention provides an illuminated inflatable object formed of at least two pieces of material, wherein each of the at least two pieces of material has an exterior surface and an interior surface, wherein each of the at least two pieces of material is permanently affixed to at least one other piece of material of the at least two pieces of material, and wherein the at least two pieces of material define at least one interior chamber, at least one valve for delivering a fluid to and removing the fluid from the at least one interior chamber, at least one rechargeable battery, wherein the at least one rechargeable battery is disposed in one or more of the at least one interior chamber, at least one solar panel electrically connected to one or more of the at least one rechargeable battery, wherein the at least one solar panel is disposed in one or more of the at least one interior chamber, at least one lighting source, wherein the at least one interior chamber is constructed and configured to retain the fluid, wherein the at least one rechargeable battery is operable to power one or more of the at least one lighting source, and wherein the at least one solar panel is operable to recharge one or more of the at least one rechargeable battery.

In another embodiment, the present invention provides an illuminated inflatable object formed of at least two pieces of material, wherein each of the at least two pieces of material has an exterior surface and an interior surface, wherein each of the at least two pieces of material is permanently affixed to at least one other piece of material of the at least two pieces of material, and wherein the at least two pieces of material define at least one interior chamber, at least one valve for delivering a fluid to and removing the fluid from the at least one interior chamber, at least one rechargeable battery, wherein the at least one rechargeable battery is disposed in one or more of the at least one interior chamber, at least one solar panel electrically connected to one or more of the at least one rechargeable battery, wherein the at least one solar panel is disposed in one or more of the at least one interior chamber, at least one lighting source, wherein the at least one lighting source is disposed in one or more of the at least one interior chamber, at least one antenna, wherein the at least one antenna is disposed in one or more of at least one interior chamber, wherein the at least one interior chamber is constructed and configured to retain the fluid, wherein the interior surface of each of the at least two pieces of material is comprised of at least one layer of a waterproof material, wherein the at least one rechargeable battery is operable to power one or more of the at least one lighting source, wherein the at least one solar panel is operable to recharge one or more of the at least one rechargeable battery, and wherein the illuminated inflatable object is operable to receive input data from at least one remote device via the at least one antenna.

In yet another embodiment, the present invention provides an illuminated inflatable chair formed of at least two pieces of material, wherein each of the at least two pieces of material has an exterior surface and an interior surface, wherein each of the at least two pieces of material is permanently affixed to at least one other piece of material of the at least two pieces of material, wherein the at least two pieces of material define at least one interior chamber, wherein the at least two pieces of material define a seat part and a back part, at least one valve for delivering a fluid to and removing the fluid from the at least one interior chamber, at least one rechargeable battery, wherein the at least one rechargeable battery is disposed in one or more of the at least one interior chamber, at least one solar panel electrically connected to one or more of the at least one rechargeable battery, wherein the at least one solar panel is disposed in one or more of the at least one interior chamber, at least one lighting source, wherein the at least one lighting source is disposed in one or more of the at least one interior chamber, and at least one antenna, wherein the at least one antenna is disposed in one or more of at least one interior chamber, wherein the at least one interior chamber is constructed and configured to retain the fluid, wherein the interior surface of each of the at least two pieces of material is comprised of at least one layer of a waterproof material, wherein the at least one rechargeable battery is operable to power one or more of the at least one lighting source, wherein the at least one solar panel is operable to recharge one or more of the at least one rechargeable battery, and wherein the illuminated inflatable chair is operable to receive input data from at least one remote device via the at least one antenna.

None of the prior art discloses an illuminated inflatable object with an embedded solar panel that is operable to recharge at least one battery used to power at least one lighting source embedded within the illuminated inflatable object.

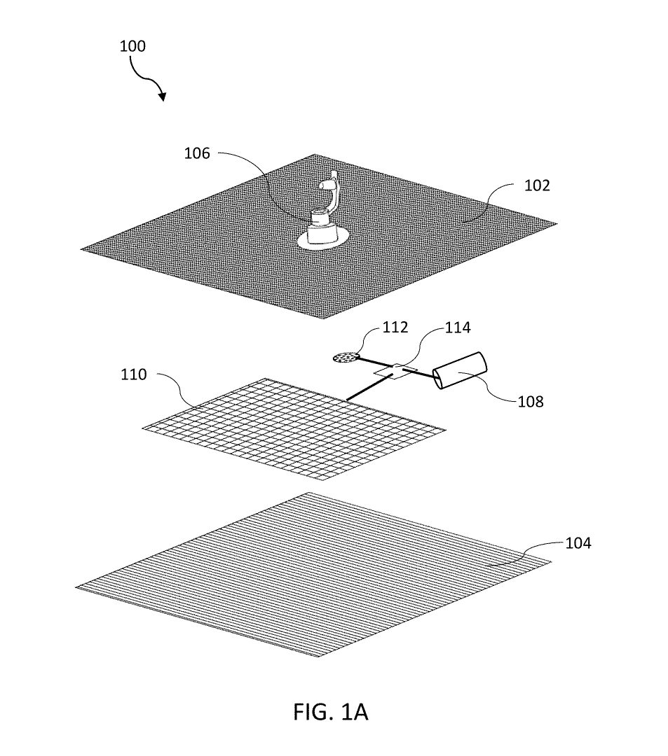

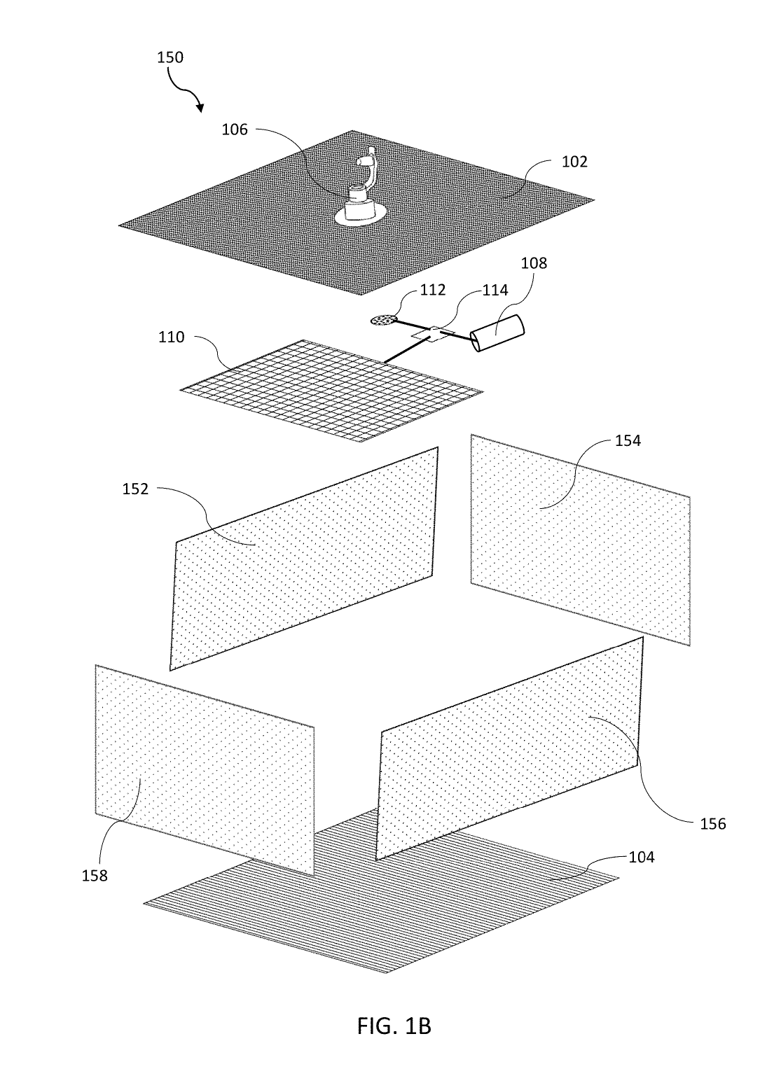

FIG. 1A illustrates an exploded view of one embodiment of an illuminated inflatable object 100. The illuminated inflatable object 100 includes at least two layers of a waterproof material that are laminated, affixed to each other, adhered to each other, attached to each other, secured to each other, or welded together to prevent separation or delamination of the layers. In a preferred embodiment, the waterproof material is a flexible plastic. In another preferred embodiment, the waterproof material is polyvinyl chloride (PVC). In one embodiment, the waterproof material is a PVC coated fabric (e.g., vinyl, nylon). Alternatively, the waterproof material is a polyolefin, polyurethane, or a polyester.

In a preferred embodiment, a first layer of the waterproof material 102 is permanently affixed to a second layer of the waterproof material 104. The first layer of the waterproof material 102 has an exterior surface and an interior surface. The second layer of the waterproof material 104 has an exterior surface and an interior surface. In a preferred embodiment, the first layer of the waterproof material 102 is welded (e.g., using high frequency/radio frequency (RF) welding or heat welding) to the second layer of the waterproof material 104 along a continuous perimeter, creating at least one interior chamber constructed and configured to retain a fluid (e.g., air, helium, hydrogen, nitrogen) without leaking between the interior surface of the first layer of the waterproof material 102 and the interior surface of the second layer of the waterproof material 104. The fluid is delivered to the at least one interior chamber via an inflation opening 106. In a preferred embodiment, the inflation opening 106 is a valve (e.g., air valve).

The illuminated inflatable object 100 includes at least one lighting source 112. In a preferred embodiment, the at least one lighting source 112 includes at least one light emitting diode (LED). The at least one LED is a single-color LED, a bi-color LED, a tri-color LED, and/or a multicolor LED. In a preferred embodiment, the at least one LED includes at least one tri-color LED with separate red, green, and blue LED chips inside, also known as an “RGB LED”. Advantageously, the RGB LED allows for color mixing instead of appearing as three separate LEDs. For example, this allows the RGB LED to produce a uniform purple color instead of appearing as a red LED and a blue LED.

In another embodiment, the at least one lighting source 112 includes at least one electroluminescent (EL) light (e.g., EL wire, EL panel, EL tape, EL paint). The EL light is electrically connected to an inverter to convert a voltage to a high frequency. In one embodiment, the EL light is sound activated. Advantageously, the EL light requires a low amount of power.

The illuminated inflatable object 100 is preferably powered using at least one battery 108. The at least one battery 108 is rechargeable or non-rechargeable. In one embodiment, the at least one battery 108 is an electrochemical battery cell. In a preferred embodiment, the at least one battery 108 is a lithium ion rechargeable battery. In one embodiment, the electrochemical battery cell is a 14430, 14500, 16650, 18350, 18500, 18650, 21700, or 26650 cylindrical cell. In another embodiment, the at least one battery 108 is a plurality of battery cells configured in series, parallel, or a combination thereof.

In a preferred embodiment, the at least one battery 108 is removably disposed within a battery compartment (not shown). For example, the at least one battery 108 can be replaced if it no longer holds a sufficient charge. The battery compartment is preferably formed of injection molded plastic. The battery compartment preferably includes at least one gasket to prevent environmental elements (e.g., water) from entering the battery compartment. Alternatively, the at least one battery 108 is sealed within the battery compartment. This embodiment provides additional waterproofing to the illuminated inflatable object. Additionally, it may provide a cost savings to seal the at least one battery 108 within the battery compartment.

The at least one battery 108 is preferably operable to be recharged using at least one solar panel 110. In a preferred embodiment, the at least one solar panel 110 is positioned in one or more of the at least one interior chamber of the illuminated inflatable object 100. The at least one solar panel 110 is preferably fully enclosed within the illuminated inflatable object 100. In one example, the illuminated inflatable object is formed of a white or cream PVC (e.g., pearl white) with a thickness of 0.30 mm and the at least one solar panel 110 is positioned in and fully enclosed within the at least one interior chamber of the illuminated inflatable object 100. This provides the aesthetic advantage of hiding the at least one solar panel 110 from view, while still providing sufficient light to the at least one solar panel 110 to charge the at least one battery 108. The at least one solar panel 110 is preferably flexible. Alternatively, the at least one solar panel 110 is rigid. Materials for forming the at least one solar panel 110 include, but are not limited to, amorphous silicon, an anti-reflection coating, cadmium telluride (CdTe), a carbon fullerene, copper indium gallium (di)selenide (CIGS), copper phthalocyanine, copper zinc tin sulfide (CZTS), copper zinc tin selenide (CZTSe), copper zinc tin sulfide/selenide (CZTSSe), dye-sensitized solar cells (DSSCs), fullerene derivatives (e.g., phenyl-C61-butyric acid methyl ester (PCBM)), gallium arsenide (GaAs), gallium indium phosphide (GaInP), germanium, graphene, Grätzel cells, kesterite, lanthanide-doped materials (e.g., Er³⁺, Yb³⁺, Ho³⁺), monocrystalline silicon, multicrystalline silicon, multijunction solar cells, organic solar cells, perovskite solar cells, polycrystalline silicon on glass, polymer solar cells, polyphenylene vinylene, quantum dot solar cells, silicon nitride, thin film solar cells, and/or titanium dioxide.

In one embodiment, the illuminated inflatable object 100 is operable to obtain power from an alternating current (AC) adapter (not shown). In one embodiment, the AC adapter is operable to recharge the at least one battery 108. The AC adapter mates to a port on the illuminated inflatable object. The illuminated inflatable object 100 preferably includes a cap to seal the port from environmental elements (e.g., water, dust) while not in use. Alternatively, the at least one battery 108 is recharged using an inductive charger.

In a preferred embodiment, the at least one battery 108, the at least one solar panel 110, and the at least one lighting source 112 are connected via at least one circuit board 114. In one embodiment, the at least one circuit board 114 includes at least one driver for at least one LED. In one embodiment, the at least one driver is a constant voltage LED driver or a constant current LED driver. In yet another embodiment, the at least one circuit board 114 includes a clamping circuit and/or a clipping circuit to prevent overpowering the at least one lighting source 112 and/or the at least one battery 108.

In another embodiment, the at least one circuit board 114 includes at least one processor. By way of example, and not limitation, the processor may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or manipulate information in any other way known in the art. In one embodiment, one or more of the at least one processor is operable to run predefined programs stored in at least one memory of the illuminated inflatable object 100.

The at least one circuit board 114 preferably includes at least one antenna, which allows the illuminated inflatable object 100 to receive and process input data (e.g., color settings, brightness settings, lighting type settings, power settings) from at least one remote device (e.g., remote control, smartphone, tablet, laptop computer). In a preferred embodiment, the at least one remote device is in wireless network communication with the illuminated inflatable object 100. The wireless communication is, by way of example and not limitation, WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, or other similar commercially utilized standards.

The at least one remote device preferably has a user interface (e.g., buttons on a remote control, a mobile application for a smartphone or tablet) that allows a user to select input data for the illuminated inflatable object 100. In a preferred embodiment, the at least one remote device is operable to set color settings for the illuminated inflatable object 100. In one embodiment, the color settings for the illuminated inflatable object 100 are preprogrammed for a selected number of colors (e.g., sixteen colors). In a preferred embodiment, the selected number of colors includes red, green, blue, and white. Additionally, or alternatively, the at least one remote device is operable to increase and/or decrease the amount of white, red, green, and/or blue light in the illuminated inflatable object 100. Advantageously, this allows a user to select at least one customized color for the illuminated inflatable object 100. In one embodiment, settings for the at least one customized color are operable to be stored in the at least one processor of the at least one remote device and/or the at least one processor of the illuminated inflatable object 100. In another preferred embodiment, the at least one remote device is operable to increase and/or decrease brightness settings for the illuminated inflatable object 100. In one embodiment, the at least one remote device is operable to set lighting type settings. The lighting type settings include, but are not limited to, a flash setting, a strobe setting, a fade setting, a smooth setting, and/or a static setting. In one embodiment, the at least one remote device is operable to change a speed (i.e., faster or slower) of the flash setting, the strobe setting, the fade setting, and/or the smooth setting. The at least one remote device is preferably operable to turn the illuminated inflatable object 100 on and off.

In another preferred embodiment, the illuminated inflatable object is formed of at least two pieces of material. Each piece of material of the at least two pieces of material has an exterior surface and an interior surface. Each piece of material of the at least two pieces of material is permanently affixed to at least one other piece of material of the at least two pieces of material. The at least two pieces of material define at least one interior chamber constructed and configured to retain a fluid (e.g., air, helium, hydrogen, nitrogen) without leaking. The at least two pieces of material are operable to form any desired three-dimensional shape when fully inflated.

FIG. 1B illustrates an exploded view of another embodiment of an illuminated inflatable object 150. In the example shown in FIG. 1B, the illuminated inflatable object is an illuminated inflatable cuboid. The first layer of the waterproof material 102 is permanently affixed to a first vertical panel 152, a second vertical panel 154, a third vertical panel 156, and a fourth vertical panel 158. The second layer of the waterproof material 104 is permanently affixed to the first vertical panel 152, the second vertical panel 154, the third vertical panel 156, and the fourth vertical panel 158. The first vertical panel 152 is permanently affixed to the second vertical panel 154 and the fourth vertical panel 158. The second vertical panel 154 is permanently affixed to the first vertical panel 152 and the third vertical panel 156. The third vertical panel 156 is permanently affixed to the second vertical panel 154 and the fourth vertical panel 158. The fourth vertical panel 158 is permanently affixed to the first vertical panel 152 and the third vertical panel 156. An interior chamber is defined between the interior surface of the first layer 102, the interior surface of the second layer 104, an interior surface of the first vertical panel 152, an interior surface of the second vertical panel 154, an interior surface of the third vertical panel 156, and an interior surface of the fourth vertical panel 158. The vertical panels are formed of a waterproof material in a preferred embodiment of the present invention, and are laminated, affixed to each other, adhered to each other, attached to each other, secured to each other, or welded together to prevent separation or delamination of the layers. In a preferred embodiment, the waterproof material is a flexible plastic. In another preferred embodiment, the waterproof material is polyvinyl chloride (PVC). In one embodiment, the waterproof material is a PVC coated fabric (e.g., vinyl, nylon). Alternatively, the waterproof material is a polyolefin, polyurethane, or a polyester.

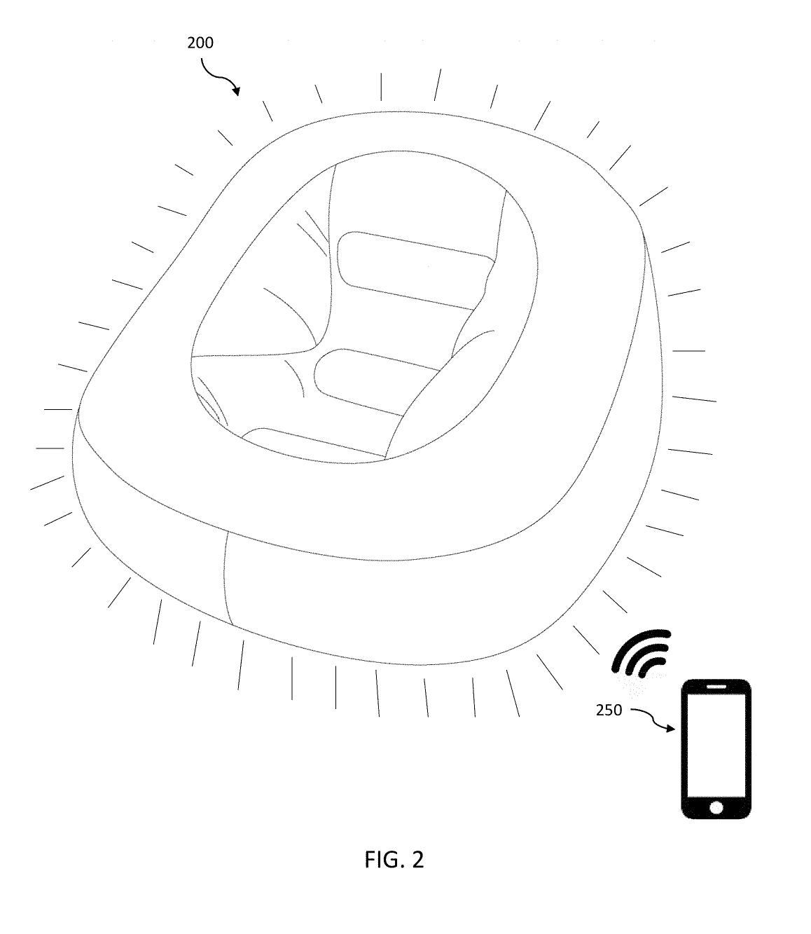

In one embodiment, the illuminated inflatable object is an illuminated inflatable chair. FIG. 2 illustrates a front perspective view of one embodiment of an illuminated inflatable chair in an illuminated state. In this embodiment, the illuminated inflatable chair 200 receives input data from at least one remote device 250.

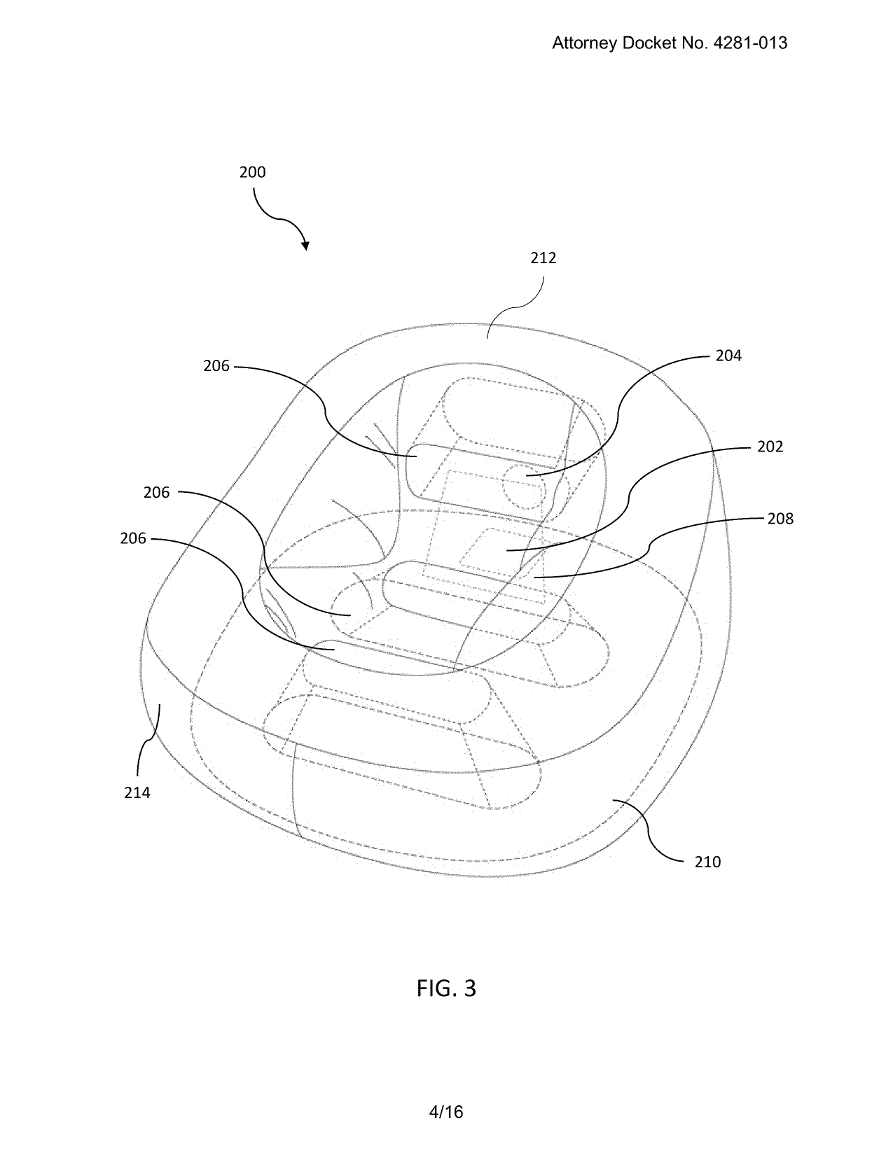

FIG. 3 illustrates a front perspective view of the illuminated inflatable chair of FIG. 2, including internal components. In the embodiment shown in FIG. 3, the illuminated inflatable chair 200 includes at least one solar panel 202. The at least one solar panel 202 is operable to recharge at least one battery (not shown) used to power at least one lighting source 204. The at least one lighting source 204 is preferably at least one LED. The illuminated inflatable chair 200 includes at least one elongated coil 206 (e.g., three elongated coils 206). The at least one elongated coil 206 is preferably made of a translucent material (e.g., clear PVC). Advantageously, this provides the lowest impact on the amount of solar energy received by the at least one solar panel 202 by allowing the maximum amount of solar energy to pass through the translucent material. In contrast, an opaque or a semi-transparent material would prevent a significantly larger amount of solar energy from reaching the at least one solar panel 202. The illuminated inflatable chair 200 includes at least one I-beam coil 208. The at least one I-beam coil 208 is preferably made of a translucent material (e.g., PVC). Advantageously, this provides the lowest impact on the amount of solar energy received by the at least one solar panel 202 by allowing the maximum amount of solar energy to pass through the translucent material. In contrast, an opaque or a semi-transparent material would prevent a significantly larger amount of solar energy from reaching the at least one solar panel 202. In an alternative embodiment, the illuminated inflatable chair 200 includes at least one standard coil, at least one X-coil, and/or at least one C-coil.

The at least one elongated coil, the at least one I-beam coil, the at least one standard coil, the at least one X-coil, and/or the least one C-coil are formed of a material that connects a top surface and a bottom surface to provide structural support to form the three-dimensional shape of the illuminated inflatable object. In one embodiment, the material is PVC. Further, the at least one elongated coil, the at least one I-beam coil, the at least one standard coil, the at least one X-coil, and/or the least one C-coil provide structural support necessary to allow the illuminated inflatable object to hold weight (e.g., a person on an illuminated inflatable chair). An elongated coil is an oval shape, an I-beam coil is shaped like the letter “I”, a standard coil is a circular shape, an X-coil is shaped like the letter “X”, and a C-coil is shaped like the letter “C”.

The illuminated inflatable chair 200 includes a base 210, a top piece 212, and a tapered piece 214. The base 210, the top piece 212, and the tapered piece 214 are preferably formed of PVC. In a preferred embodiment, the base 210 is substantially flat, allowing the illuminated inflatable chair 200 to lie flat on a surface. In one embodiment, the base 210 has rounded edges. In another embodiment, the top piece 212 is substantially round in shape. The tapered piece 214 is permanently affixed to the base 210 and the top piece 212. The tapered piece 214 varies in height such that a distance between the base 210 and the top piece 212 is greatest at a back of the illuminated inflatable chair 200 and smallest at a front of the illuminated inflatable chair 200. The tapered piece 214 forms angled sides of the illuminated inflatable chair 200, causing the top piece 212 to be angled between about 10 degrees and about 60 degrees relative to the base 210.

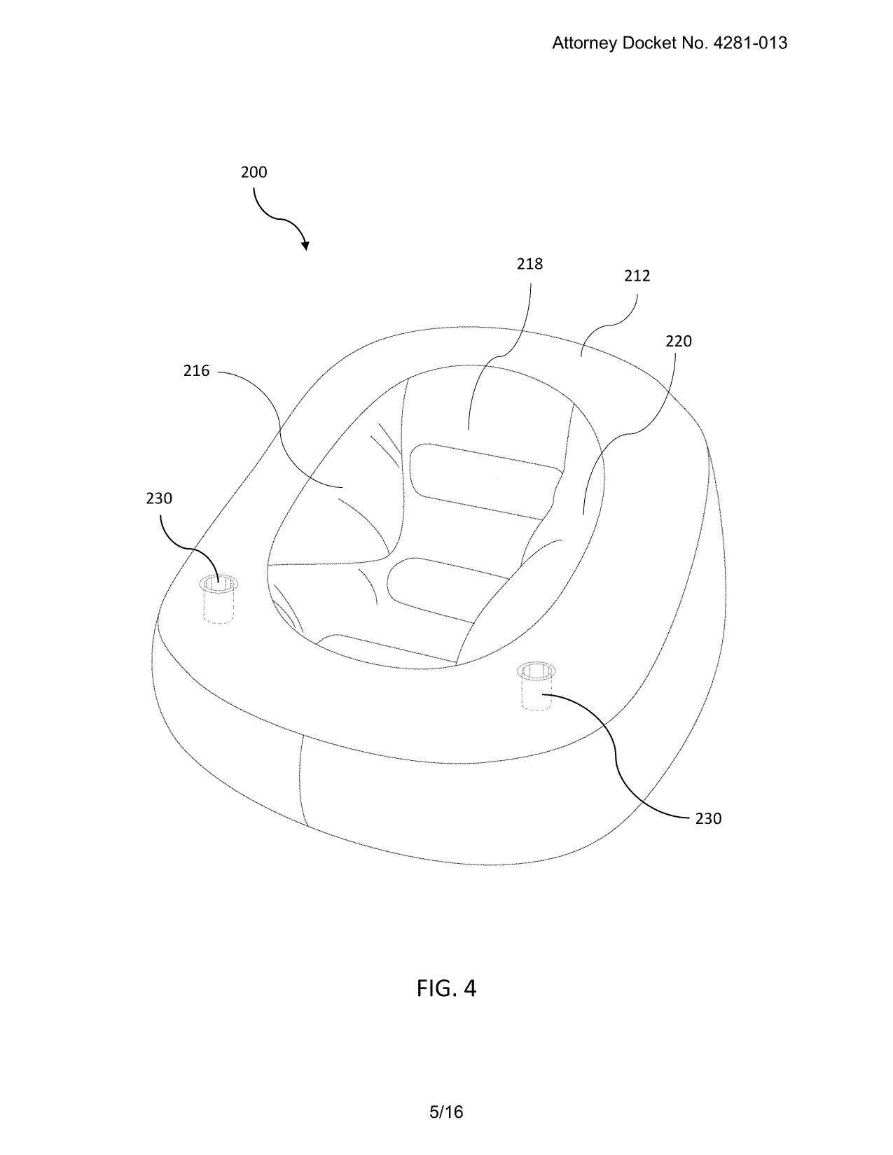

As shown in FIG. 4, a seating portion is formed of a left sidewall 216, a center portion 218, and a right sidewall 220. The left sidewall 216 is permanently affixed to the top piece 212 and the center portion 218. The center portion 218 is permanently affixed to the top piece 212 and the center portion 218. The right sidewall 220 is permanently affixed to the top piece 212 and the center portion 218. The seating portion forms a substantially semi-spherical shape. In one embodiment, one or more of the at least one elongated coil 206 (e.g., two elongated coils 206) are positioned between the center portion 218 and the base 210. In another embodiment, one or more of the at least one elongated coil 206 (e.g., one elongated coil 206) is positioned between the center portion 218 and the tapered piece 214.

FIG. 4 illustrates a front perspective view of another embodiment of an illuminated inflatable chair. In the embodiment shown in FIG. 4, the illuminated inflatable chair 200 has at least one cup holder 230 (e.g., two cupholders 230).

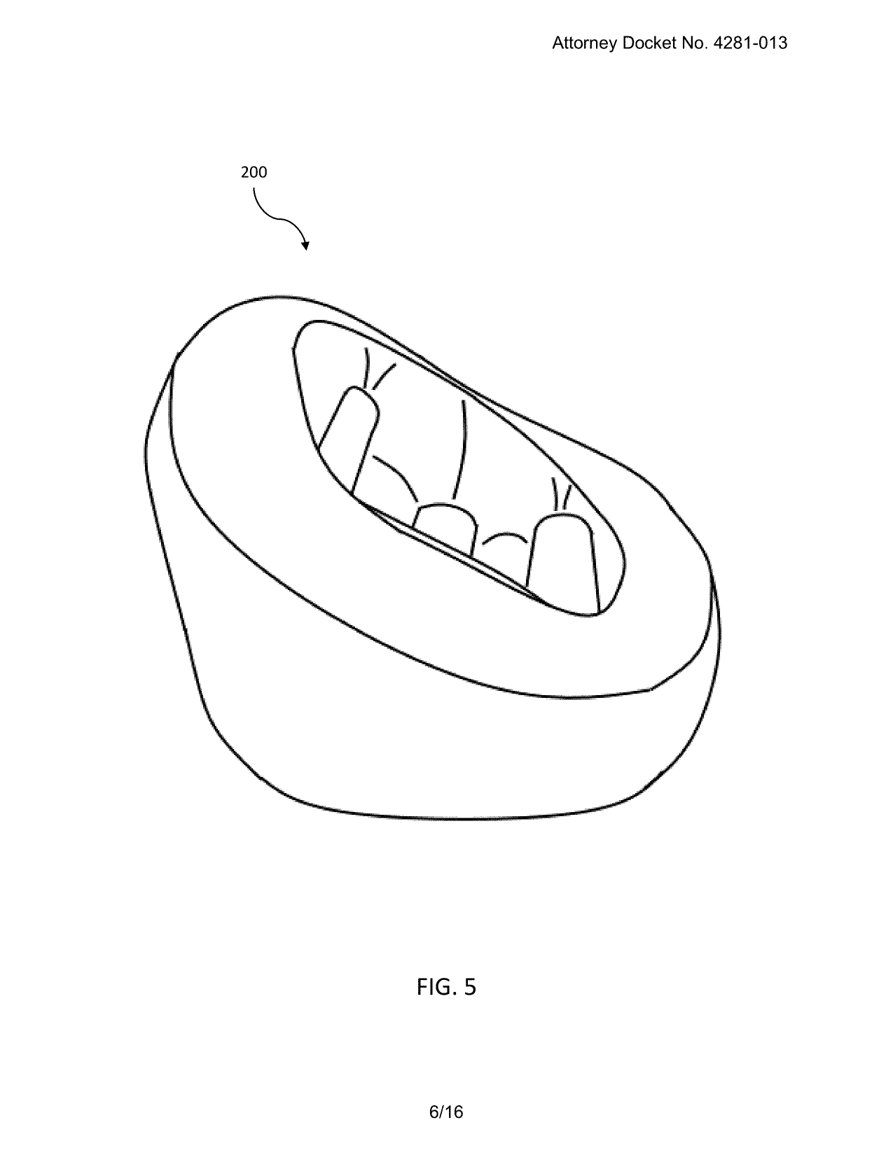

FIG. 5 illustrates a side perspective view of the embodiment of an illuminated inflatable chair shown in FIG. 2.

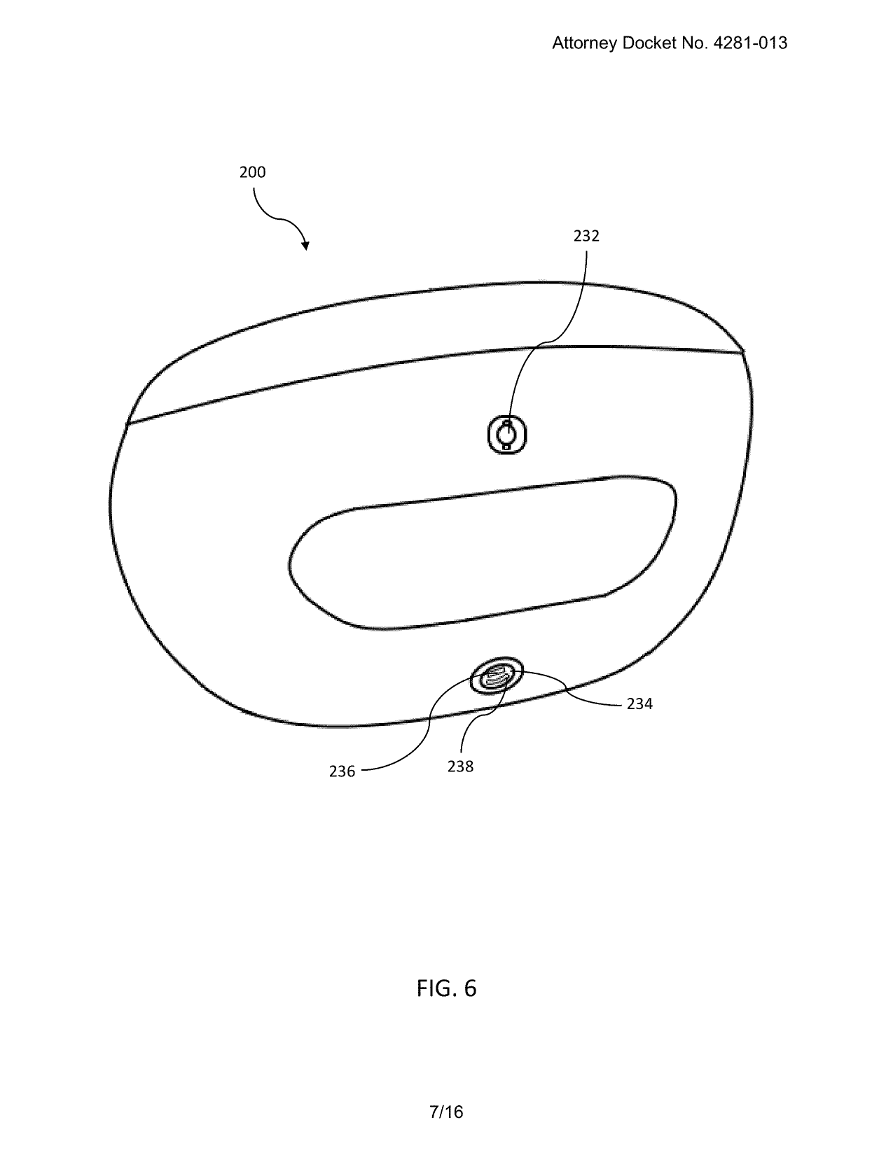

FIG. 6 illustrates a back perspective view of the embodiment of an illuminated inflatable chair shown in FIG. 2. The illuminated inflatable chair 200 has a valve 232 to inflate and deflate the illuminated inflatable chair 200. The illuminated inflatable chair 200 has an electronic compartment 234 that houses a battery compartment 236. The illuminated inflatable chair 200 is operable to obtain power from an alternating current (AC) adapter (not shown). The AC adapter mates to a plug on the illuminated inflatable chair 200. The illuminated inflatable chair 200 preferably includes a cover 238 to seal the plug from external elements (e.g., water, dust) while not in use. The cover 238 is preferably permanently affixed to the illuminated inflatable chair 200 at an end opposite of the plug. Advantageously, this prevents the cover 238 from being separated from the illuminated inflatable chair 200. The cover 238 is preferably formed of an elastomeric material (e.g., rubber).

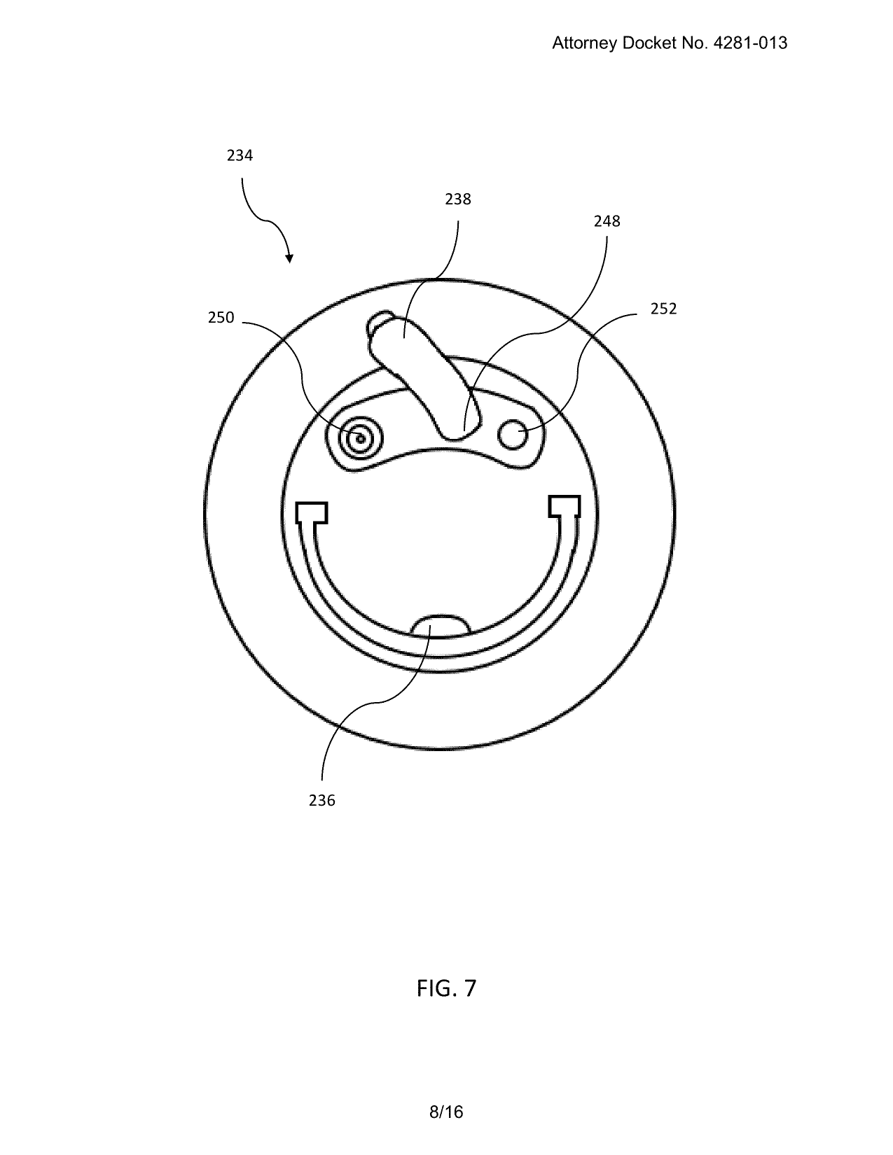

FIG. 7 illustrates one embodiment of an electronic compartment. The electronic compartment 234 houses a battery compartment 236. The illuminated inflatable chair is operable to obtain power from an alternating current (AC) adapter (not shown). The AC adapter mates to a port 250 on the illuminated inflatable chair. The illuminated inflatable chair preferably includes a cover 238 to seal the port 250 from external elements (e.g., water, dust) while not in use. The cover 238 is preferably permanently affixed to the electronic compartment 234 at an attachment point 248. Advantageously, this prevents the cover 238 from being separated from the illuminated inflatable chair. The cover 238 is preferably formed of an elastomeric material (e.g., rubber). The electronic compartment 234 includes a power button 252 operable to turn the illuminated inflatable chair on and off.

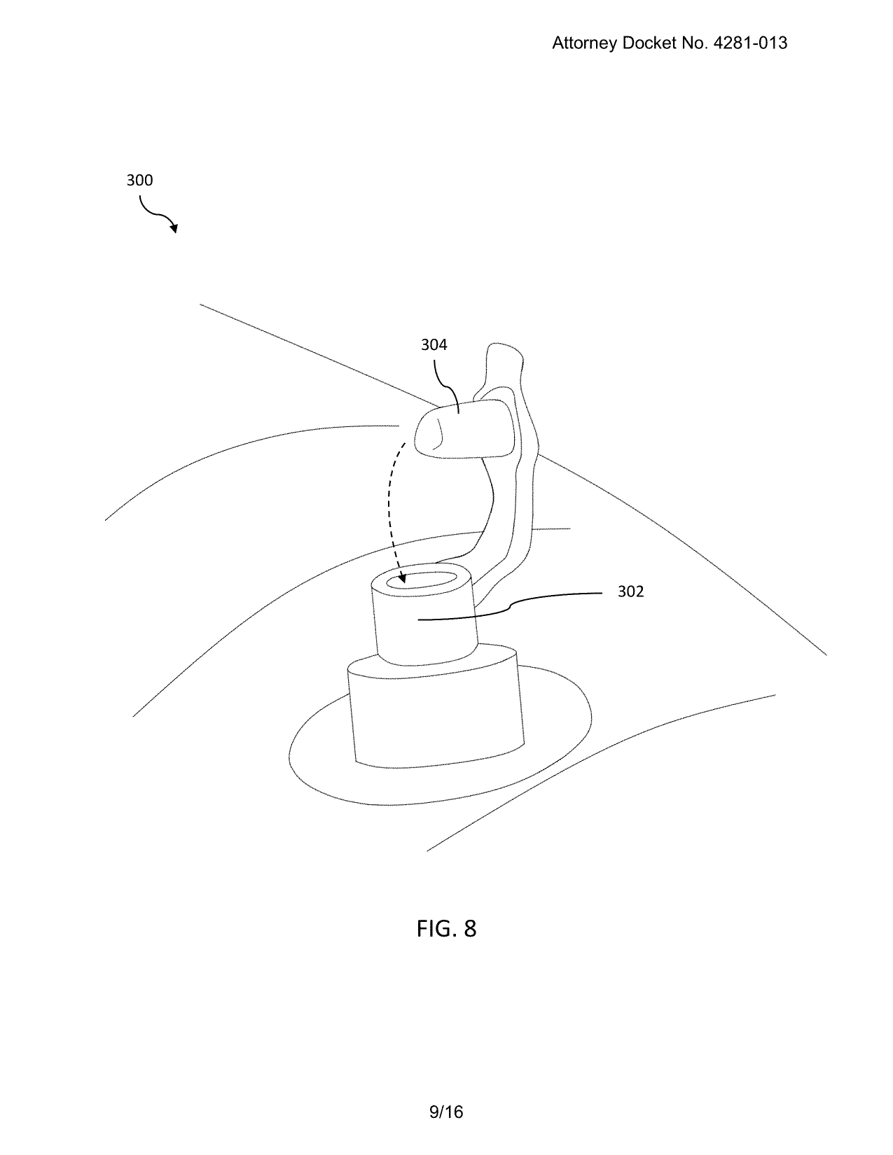

As previously described, a fluid (e.g., air, helium, hydrogen, helium) is delivered to and removed from the at least one interior chamber via at least one inflation opening. The at least one inflation opening is preferably a valve. FIG. 8 illustrates one embodiment of a valve 300. The at least one interior chamber is inflated via the valve 300. Fluid enters the interior chamber through the valve nipple 302 of the valve 300. A valve stopper 304 seals the valve nipple 302 to retain the fluid in the at least one interior chamber. The at least one interior chamber is deflated by removing the valve stopper 304, allowing the fluid to exit through the valve nipple 302. The valve 300 is preferably operable to be pushed in such that the valve 300 is substantially flush with an exterior surface of the waterproof material. In one embodiment, the at least one interior chamber is inflated using an external pump. The external pump is preferably powered by alternating current (AC). In another embodiment, the at least one interior is inflated using an internal pump.

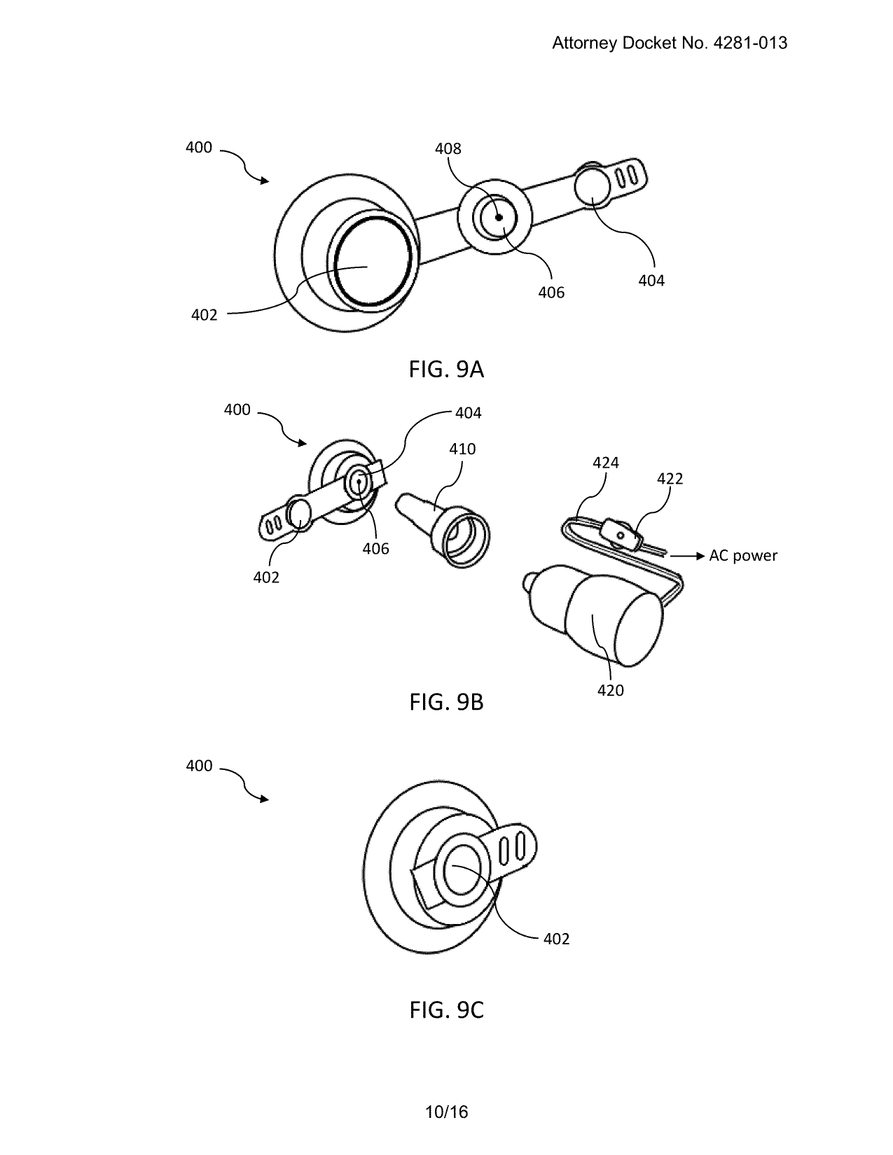

FIG. 9A illustrates another embodiment of a valve 400. The at least one interior chamber is inflated via the valve 400. The valve 400 has a mouth 402, a primary cap 404, and a secondary cap 406. The secondary cap 406 has a hole 408. To inflate the at least one interior chamber, the secondary cap 406 is placed over the mouth 402 as shown in FIG. 9B. A nozzle 410 is placed on an end of a pump 420. The pump 420 has a switch 422 on an attached electrical cord 424. The attached electrical cord 424 is operable to attach to an electrical outlet (not shown) via a plug (not shown). The electrical outlet provides the pump 420 with AC power. The pump 420 inflates the at least one interior chamber by pushing air through the hole in the secondary cap 406. After the at least one interior chamber is inflated, the primary cap 404 is placed over the secondary cap 406 to seal the at least one interior chamber as shown in FIG. 9C. To deflate the at least one interior chamber, the primary cap 404 and the secondary cap 406 are removed from the mouth 402.

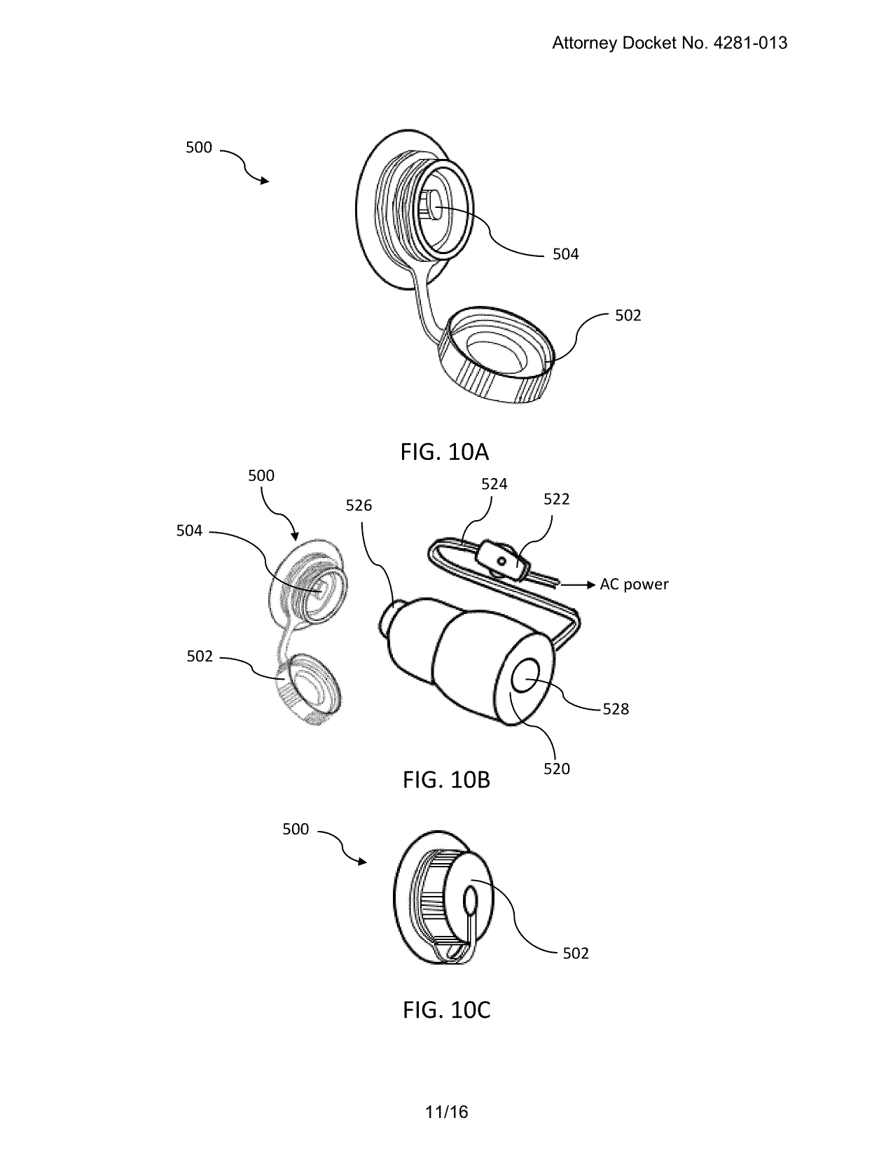

FIG. 10A illustrates another embodiment of a valve 500. The at least one interior chamber is inflated via the valve 500. The valve 500 has a cap 502 and a valve switch 504. FIG. 10B illustrates the process of inflating the valve of FIG. 10A. To inflate the at least one interior chamber, the valve switch 504 is fully retracted and an inflation nozzle 526 of a pump 520 is placed into the valve 500. The pump 520 has a switch 522 on an attached electrical cord 524. The attached electrical cord 524 is operable to attach to an electrical outlet (not shown) via a plug (not shown). The electrical outlet provides the pump 520 with AC power. After placing the switch 522 in an on position, the pump 520 inflates the at least one interior chamber by pushing air into the valve 500 via the valve switch 504. After the at least one interior chamber is inflated, the switch 522 is placed in an off position, the cap 502 is closed to seal the at least one interior chamber as shown in FIG. 9C. To deflate the at least one interior chamber, the cap 502 is removed from the valve 500. The valve switch 504 is pushed in and a deflation nozzle 528 of the pump 520 is placed into the valve 500. After placing the switch 522 in an on position, the pump 520 deflates the at least one interior chamber. After the at least one interior chamber is deflated, the switch 522 is placed in an off position.

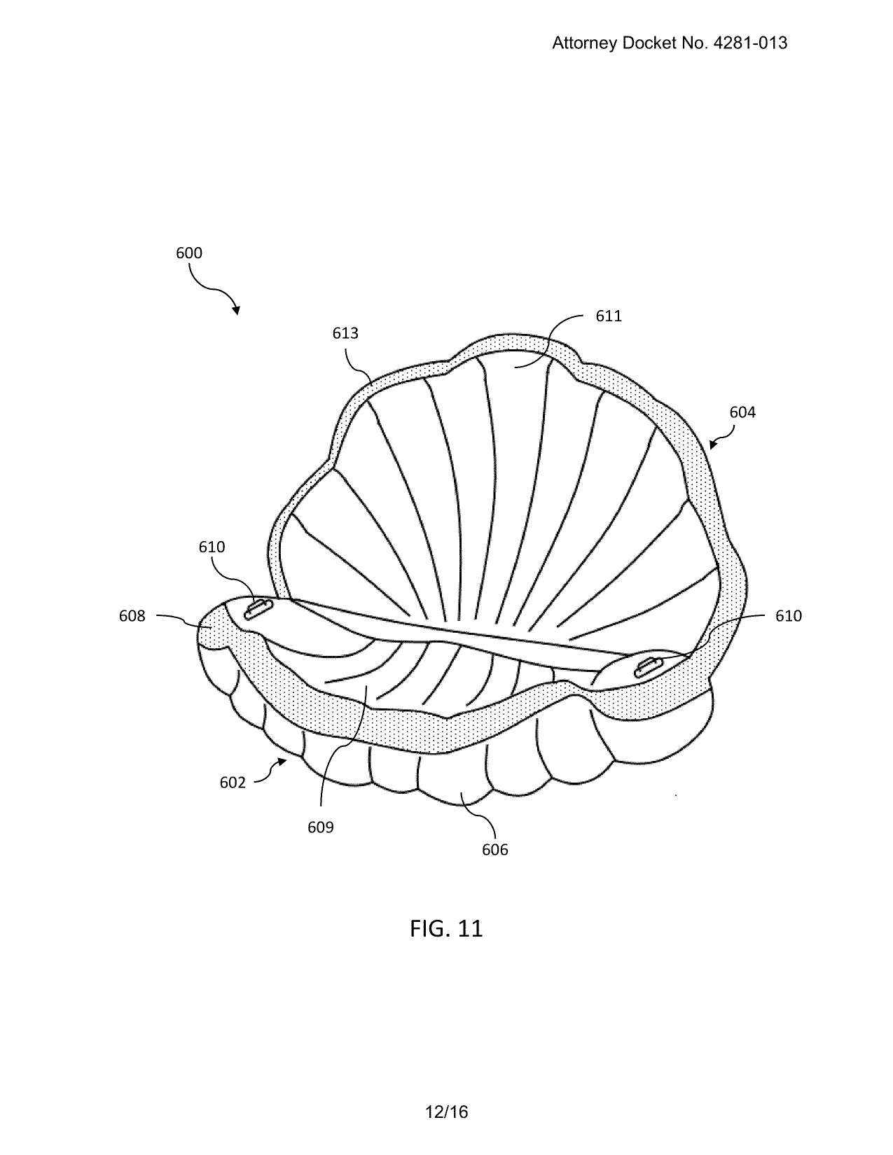

In one embodiment, the illuminated inflatable object is an illuminated inflatable shell float. FIG. 11 illustrates a side perspective view of an illuminated inflatable shell float 600. The illuminated inflatable shell float 600 is preferably formed of PVC. The illuminated inflatable shell float 600 has a seat portion 602 and a back portion 604.

In one embodiment, the seat portion 602 is formed of three seat pieces of PVC. A first seat piece of PVC 606 is formed of a white or cream PVC (e.g., pearl white PVC), a second seat piece of PVC 608 is formed of an iridescent PVC, and a third seat piece of PVC 609 is formed of the white or cream PVC. In one embodiment, the white or cream PVC has a thickness of 0.30 mm. The second seat piece of PVC 608 is permanently affixed to the first seat piece of PVC 606 and the third seat piece of PVC 609. The first seat piece of PVC 606 forms a floating surface, while the third seat piece of PVC 609 forms a seating surface. In one embodiment, the seating surface has a curvature. The seat portion 602 preferably includes at least one handle 610 (e.g., two handles 610) to allow a user to climb on and off the illuminated inflatable shell float 600.

The seat portion 602 preferably is an integrally formed shell shape including a plurality of horizontal ribs. The plurality of horizontal ribs is preferably formed of at least one I-beam coil and/or at least one X-beam coil. In one embodiment, each of the plurality of horizontal ribs is curved. In another embodiment, the horizontal ribs are tapered such that the horizontal ribs increase in width and/or depth from the back of the seat portion to the front edge of the seat portion. The horizontal ribs are symmetrical about a vertical plane which perpendicularly intersects the seat portion 602 in one embodiment. Alternatively, the horizontal ribs are asymmetrical about a vertical plane which perpendicularly intersects the seat portion 602. Preferably, a center horizontal rib has the longest length out of the plurality of horizontal ribs, and each of the horizontal ribs on the immediate right and left of the center horizontal rib has a shorter length than the center horizontal rib, with the horizontal ribs on the immediate right and left of the center horizontal rib having equal or substantially equal lengths in one embodiment. Similarly, each of the horizontal ribs to the left of the horizontal rib immediately to the left of the center horizontal rib has a longer length than the preceding horizontal rib closer to the center horizontal rib, and each of the horizontal ribs to the right of the horizontal rib immediately to the right of the center horizontal rib has a longer length than the preceding horizontal rib closer to the center horizontal rib.

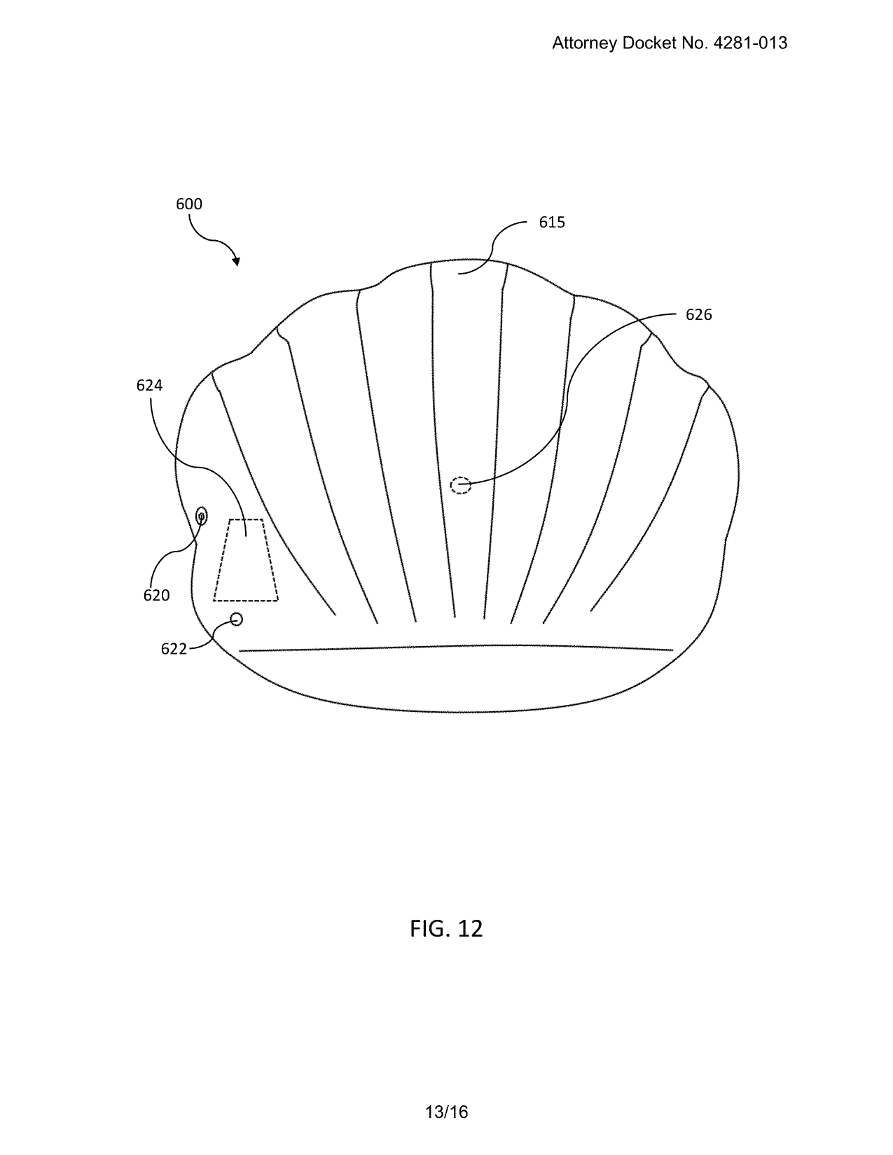

In one embodiment, the back portion 604 is formed of three back pieces of PVC. A first back piece of PVC 611 is formed of a white or cream PVC (e.g., pearl white PVC), a second back piece of PVC 613 is formed of an iridescent PVC, and a third back piece of PVC (illustrated in FIG. 12 as 615) is formed of the white or cream PVC (e.g., pearl white PVC). In one embodiment, the white or cream PVC has a thickness of 0.30 mm. The second back piece of PVC 613 is permanently affixed to the first back piece of PVC 611 and the third back piece of PVC 615. The first back piece of PVC 611 forms a back-rest surface, while the third back piece of PVC 615 forms a rear-facing surface. In one embodiment, the back-rest surface has a curvature. In one embodiment, the first back piece of PVC 611 and the third seat piece of PVC 609 are permanently affixed to each other. The third back piece of PVC 615 and first seat piece of PVC 606 are permanently affixed to each other in another embodiment of the present invention.

The back portion 604 preferably is an integrally formed shell shape including a plurality of vertical ribs. The plurality of vertical ribs is preferably formed of at least one I-beam coil and/or at least one X-beam coil. In one embodiment, each of the plurality of vertical ribs is curved. In another embodiment, the at least one I-beam coil and/or the at least one X-beam coil is formed of PVC. In one embodiment, the vertical ribs are tapered such that the vertical ribs increase in width and/or depth from the base of the back portion 604 to the top edge of the back portion 604. The vertical ribs are symmetrical about a vertical plane which perpendicularly intersects the back portion 604 in one embodiment. Alternatively, the vertical ribs are asymmetrical about a vertical plane which perpendicularly intersects the back portion 604. Preferably, a center vertical rib has the greatest height out of the plurality of vertical ribs, and each of the vertical ribs on the immediate right and left of the center vertical rib is less in height than the center vertical rib, with the vertical ribs on the immediate right and left of the center vertical rib having equal or substantially equal heights in one embodiment. Similarly, each of the vertical ribs to the left of the vertical rib immediately to the left of the center vertical rib has a shorter height than the preceding vertical rib closer to the center vertical rib, and each of the vertical ribs to the right of the vertical rib immediately to the right of the center vertical rib has a shorter height than the preceding vertical rib closer to the center vertical rib.

FIG. 12 illustrates a back perspective view of the illuminated inflatable shell float in FIG. 11, including internal components. The illuminated inflatable shell float 600 includes a third back piece of PVC 615 and a valve 620 to inflate and deflate the illuminated inflatable shell float. The illuminated shell float includes an electronics compartment 622. An interior chamber of the illuminated shell float contains a solar panel 624 and at least one lighting source 626. In a preferred embodiment, the at least one lighting source 626 is at least one LED.

In one embodiment, the illuminated inflatable object is an illuminated inflatable mattress, an illuminated inflatable pool float, or an illuminated inflatable hammock. Examples of inflatable mattresses, inflatable pool floats, and inflatable hammocks are disclosed in U.S. Pat. Nos. D571429, 5,186,667, 5,437,068, and 5,604,945, each of which is incorporated herein by reference in its entirety.

In one embodiment, the illuminated inflatable object is an illuminated inflatable cooler. Examples of inflatable coolers are disclosed in U.S. Pat. Nos. 4,085,785, 4,571,194, 4,809,352, 7,195,132 and 8,215,515 and U.S. Publication Nos. 20070023439, 20090242570, and 20170119116, each of which is incorporated herein by reference in its entirety.

In another embodiment, the illuminated inflatable object is an illuminated inflatable cooler base. Examples of an inflatable cooler bases are disclosed in U.S. Pat. Nos. 6,016,933 and D786,998, each of which is incorporated herein by reference in its entirety.

In yet another embodiment, the illuminated inflatable object is an illuminated inflatable drink holder or an illuminated inflatable bar.

In one embodiment, the illuminated inflatable object is an illuminated inflatable ball. Examples of an inflatable ball are disclosed in U.S. Pat. Nos. 4,776,589, 5,779,575, and 5,888,156, each of which is incorporated herein by reference in its entirety.

In another embodiment, the illuminated inflatable object is an illuminated constant air inflatable object. A motor or a fan blows air into the illuminated constant air inflatable object to keep the illuminated constant air inflatable object inflated.

In yet another embodiment, the illuminated inflatable object is an illuminated inflatable billiard set, an illuminated inflatable net (e.g., volleyball net, water polo net, basketball net), an illuminated inflatable beer pong table, an illuminated inflatable ring toss, an illuminated inflatable cornhole game, an illuminated inflatable obstacle course, an illuminated inflatable maze, an illuminated inflatable see-saw, an illuminated inflatable gameboard (e.g., chess, checkers), an illuminated inflatable surfboard, or an illuminated inflatable trampoline.

In alternative embodiments, the illuminated inflatable object is an illuminated inflatable cushion, an illuminated inflatable arch, an illuminated inflatable baby float, an illuminated inflatable inner tube, an illuminated inflatable life preserver, an illuminated inflatable life vest, an illuminated inflatable climbing wall, an illuminated inflatable buoy, an illuminated inflatable raft, an illuminated inflatable kayak, an illuminated inflatable boat, an illuminated inflatable paddle board, a pair of illuminated inflatable armbands (i.e., water wings), an illuminated inflatable kite, an illuminated inflatable tent, an illuminated inflatable castle, an illuminated inflatable bounce house, an illuminated inflatable slide, an illuminated inflatable swimming pool, a piece of illuminated inflatable patio furniture (e.g., chair, couch, loveseat, table), or an illuminated inflatable yard decoration.

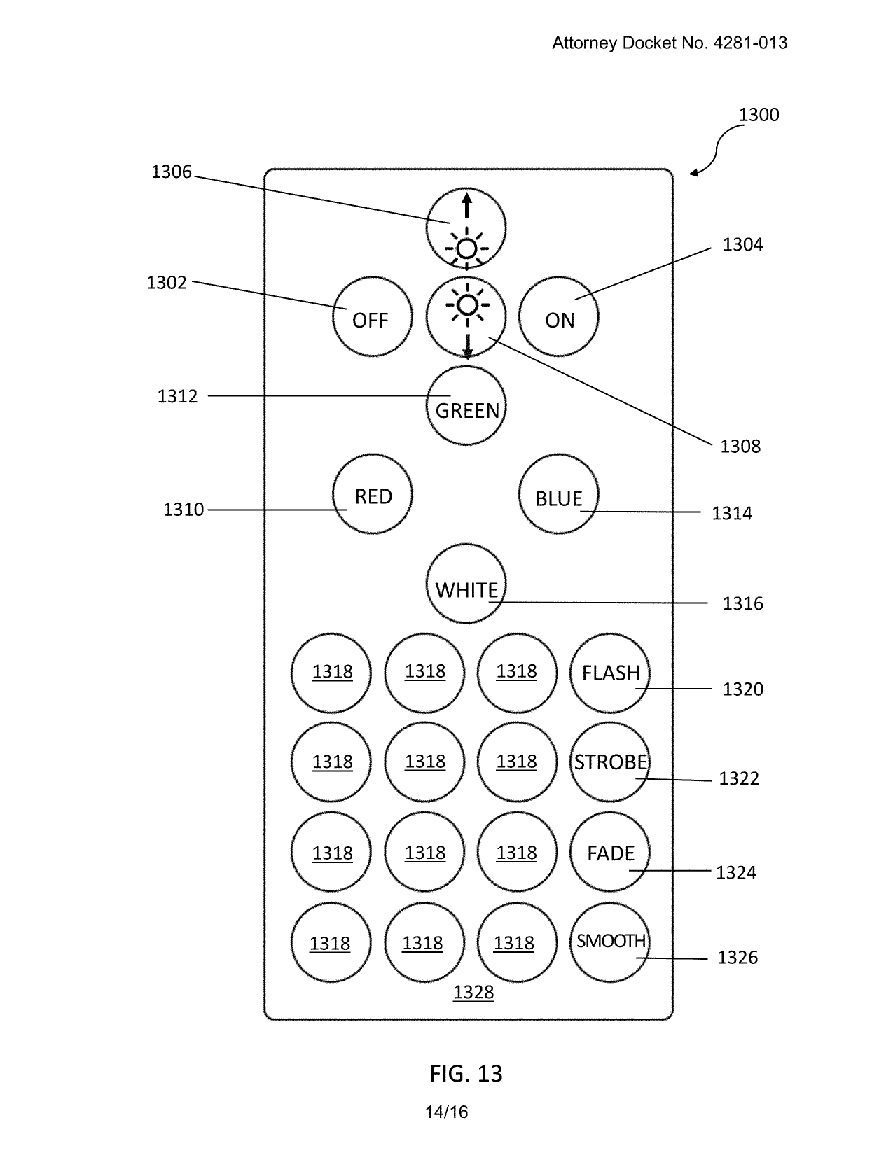

As previously described, the at least one remote device preferably has a user interface (e.g., buttons on a remote control, a mobile application for a smartphone or tablet) that allows a user to select input data for the illuminated inflatable object. FIG. 13 illustrates one embodiment of a user interface for a remote device. The user interface 1300 is on the remote device 1328 (e.g., remote control, smartphone, tablet, laptop computer). The user interface 1300 includes an off button 1302 and an on button 1304 to power the illuminated inflatable object. Alternatively, the user interface 1300 includes a power button operable to turn the illuminated inflatable object on and off. The user interface 1300 includes a brightness increase button 1306 and a brightness decrease button 1308 to increase and decrease, respectively, the brightness of the lighting. The user interface 1300 includes a red button 1310 for pure red lighting, a green button 1312 for pure green lighting, a blue button 1314 for pure blue lighting, and a white button 1316 for pure white lighting. The user interface 1300 includes a plurality of buttons 1318 (e.g., twelve buttons) for preprogrammed lighting colors. The user interface 1300 includes a flash button 1320, a strobe button 1322, a fade button 1324, and a smooth button 1326.

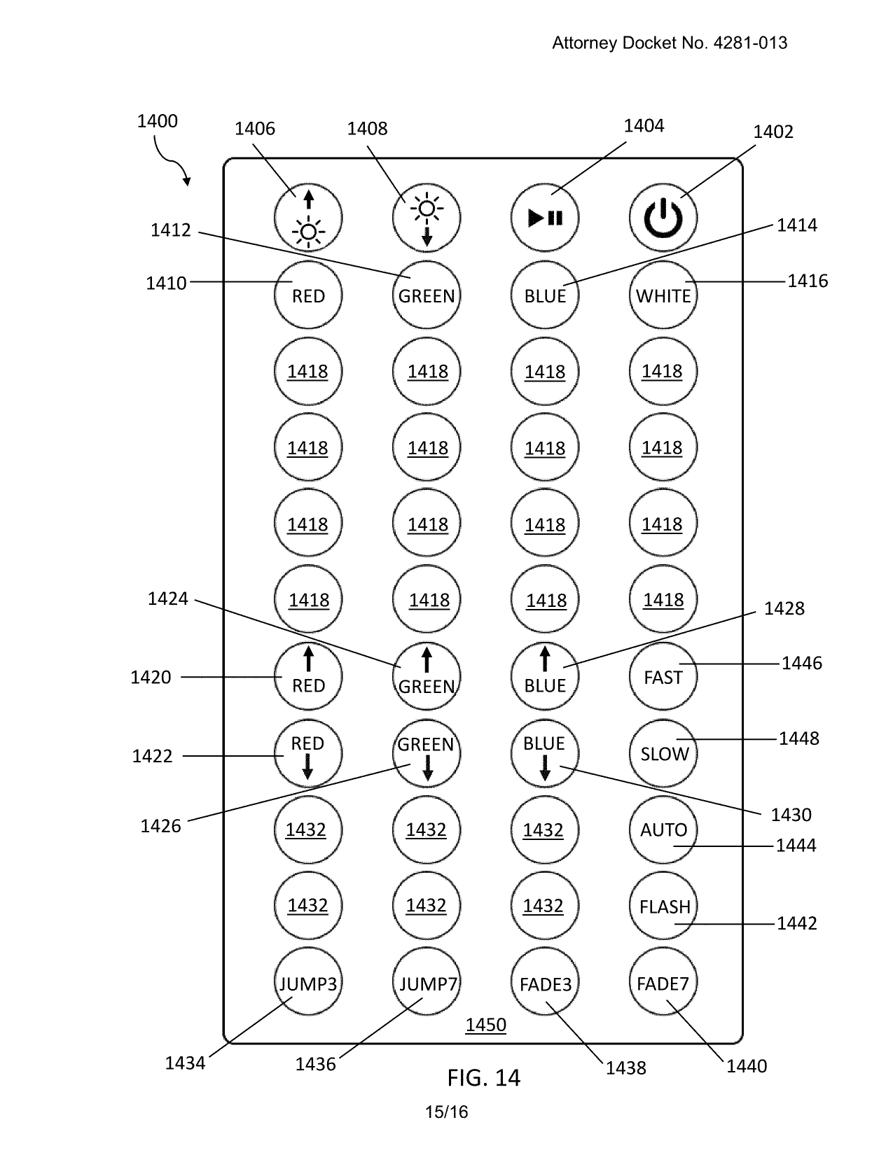

FIG. 14 illustrates another embodiment of a user interface for a remote device. The user interface 1400 is on the remote device 1450 (e.g., remote control, smartphone, tablet, laptop computer). The user interface includes a power button 1402 operable to turn the illuminated inflatable object on and off. Alternatively, the user interface includes an on button and an off button. The user interface includes a brightness increase button 1406 and a brightness decrease button 1408 to increase and decrease, respectively, the brightness of the lighting. The user interface includes a red button 1410 for pure red lighting, a green button 1412 for pure green lighting, a blue button 1414 for pure blue lighting, and a white button 1416 for pure white lighting. The user interface includes a plurality of buttons 1418 (e.g., sixteen buttons) for preprogrammed lighting colors. The user interface includes a button to increase the amount of red lighting 1420 and a button to decrease the amount of red lighting 1422. The user interface includes a button to increase the amount of green lighting 1424 and a button to decrease the amount of green lighting 1426. The user interface includes a button to increase the amount of blue lighting 1428 and a button to decrease the amount of blue lighting 1430. The user interface includes a plurality of custom buttons 1432 (e.g., six buttons) for colors customized according to user preferences. The colors customized according to user preferences that are selected by the plurality of custom buttons 1432 are selected by varying the amounts of red, green, and/or blue lighting using the button to increase the amount of red lighting 1420, the button to decrease the amount of red lighting 1422, the button to increase the amount of green lighting 1424, the button to decrease the amount of green lighting 1426, the button to increase the amount of blue lighting 1428, and/or the button to decrease the amount of blue lighting 1430.

The user interface includes a first jump button 1434 to jump between at least two colors (e.g., three colors) and a second jump button 1436 to jump between at least two colors (e.g., seven colors). The user interface includes a first fade button 1438 to fade between at least two colors (e.g., three colors) and a second fade button 1440 to fade between at least two colors (e.g., seven colors). The user interface includes a flash button 1442 to flash the lighting. The user interface includes an auto button 1444 to cycle through a plurality of colors in an automatic color changing mode. The user interface includes a fast button 1446 and a slow button 1448 to increase and decrease, respectively, the speed of lighting transitions.

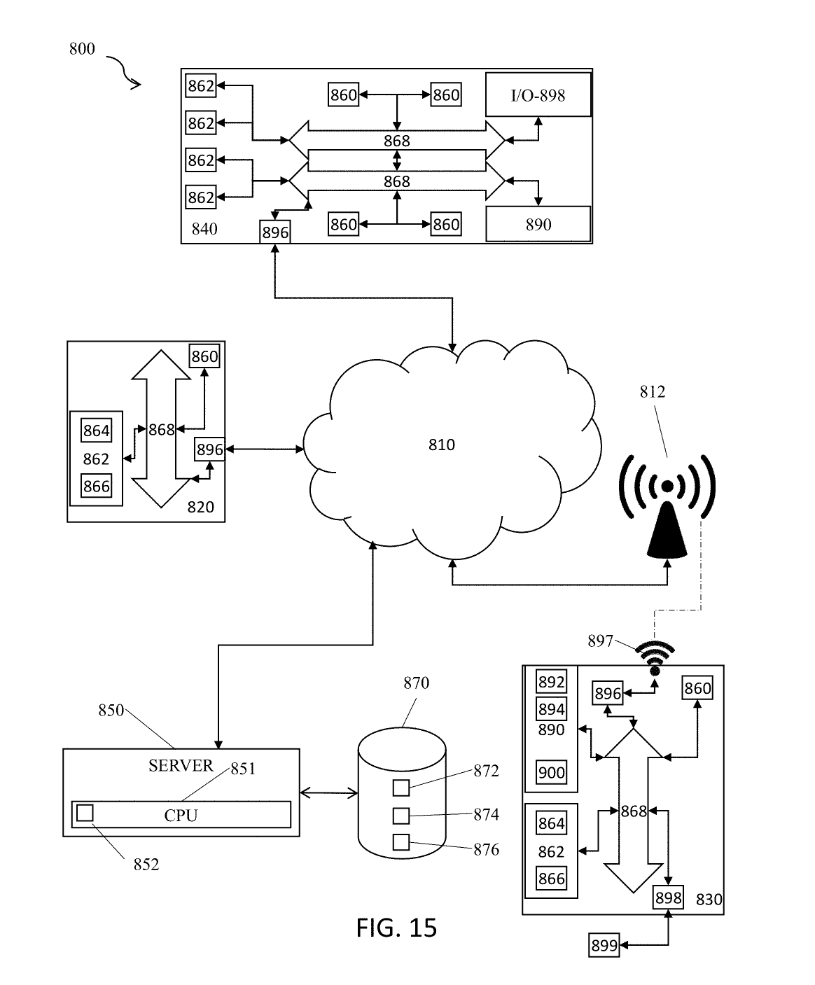

FIG. 15 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 may house an operating system 872, memory 874, and programs 876.

In one embodiment of the invention, the system 800 includes a cloud-based network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital computers 820, 840, 850 and mobile devices 830, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in this document

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 15, multiple processors 860 and/or multiple buses 868 may be used, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to a bus 868. Computing devices may communicate communication media through wired networks, direct-wired connections or wirelessly, such as acoustic, RF, or infrared, through an antenna 897 in communication with the network antenna 812 and the network interface unit 896, which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications, or other data embodying any one or more of the methodologies or functions described herein. The computer readable medium may include the memory 862, the processor 860, and/or the storage media 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

It is also contemplated that the computer system 800 may not include all of the components shown in FIG. 15, may include other components that are not explicitly shown in FIG. 15, or may utilize an architecture completely different than that shown in FIG. 15. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By way of example, the illuminated inflatable object may be an illuminated inflatable chair, an illuminated inflatable shell float, an illuminated inflatable mattress, an illuminated inflatable inner tube, an illuminated inflatable cooler, an illuminated inflatable cooler base, an illuminated inflatable drink holder, an illuminated inflatable bar, an illuminated inflatable ball, an illuminated inflatable billiard set, an illuminated inflatable net, an illuminated inflatable beer pong table, an illuminated inflatable ring toss, an illuminated inflatable cornhole game, an illuminated inflatable obstacle course, an illuminated inflatable maze, an illuminated inflatable see-saw, an illuminated inflatable gameboard, an illuminated inflatable surfboard, an illuminated inflatable trampoline, an illuminated inflatable cushion, an illuminated inflatable arch, an illuminated inflatable baby float, an illuminated inflatable climbing wall, an illuminated inflatable buoy, an illuminated inflatable raft, an illuminated inflatable kayak, an illuminated inflatable boat, an illuminated inflatable paddle board, a pair of illuminated inflatable armbands, an illuminated inflatable kite, an illuminated inflatable tent, an illuminated inflatable castle, an illuminated inflatable bounce house, an illuminated inflatable slide, an illuminated inflatable swimming pool, a piece of illuminated inflatable patio furniture, or an illuminated inflatable yard decoration. The above-mentioned examples are just some of the many configurations that the mentioned components can take on. All modifications and improvements have been deleted herein for the sake of conciseness and readability but are properly within the scope of the present invention.

The invention claimed is:

1. An illuminated inflatable object comprising:
at least two pieces of material, wherein each of the at least two pieces of material has an exterior surface and an interior surface, wherein each of the at least two pieces of material is permanently affixed to at least one other piece of material of the at least two pieces of material, and wherein the at least two pieces of material define at least one interior chamber;
at least one valve for delivering a fluid to and removing the fluid from the at least one interior chamber;
at least one rechargeable battery, wherein the at least one rechargeable battery is disposed in one or more of the at least one interior chamber;
at least one solar panel electrically connected to one or more of the at least one rechargeable battery, wherein the at least one solar panel is disposed in one or more of the at least one interior chamber;
at least one lighting source, wherein the at least one lighting source is disposed in one or more of the at least one interior chamber;
wherein the at least one interior chamber is constructed and configured to retain the fluid;
wherein the at least one rechargeable battery is operable to power one or more of the at least one lighting source; and
wherein the at least one solar panel is operable to recharge one or more of the at least one rechargeable battery.

2. The illuminated inflatable object of claim 1, wherein the at least two pieces of material include a seat portion and a back portion, wherein the seat portion includes a plurality of horizontal ribs and the back portion includes a plurality of vertical ribs.

3. The illuminated inflatable object of claim 1, wherein an interior surface of one or more of the at least two pieces of material is comprised of at least one layer of a waterproof material.

4. The illuminated inflatable object of claim 1, wherein one or more of the at least two pieces of material is comprised of polyvinyl chloride (PVC).

5. The illuminated inflatable object of claim 1, wherein the illuminated inflatable object is an illuminated inflatable chair, wherein the at least two pieces of material include a base, a top piece, and a tapered piece, wherein the tapered piece varies in height such that a distance between the base and the top piece is longest at a back of the illuminated inflatable chair and shortest at a front of the illuminated inflatable chair.

6. The illuminated inflatable object of claim 1, wherein the at least one lighting source is at least one light emitting diode and/or at least one electroluminescent (EL) light.

7. The illuminated inflatable object of claim 1, further comprising at least one elongated coil, at least one I-beam coil, and/or at least one standard coil.

8. The illuminated inflatable object of claim 1, further comprising at least one circuit board electrically connected to one or more of the at least one solar panel and/or one or more of the at least one rechargeable battery, wherein the at least one circuit board includes at least one driver for at least one light emitting diode, a clamping circuit, a clipping circuit, a processor, and/or an antenna.

9. The illuminated inflatable object of claim 1, wherein the illuminated inflatable object is operable to obtain power from an induction charger and/or an alternating current adapter.

10. The illuminated inflatable object of claim 1, wherein one or more of the at least one valve is operable to inflate the at least one interior chamber using a pump.

11. The illuminated inflatable object of claim 1, wherein the illuminated inflatable object is an illuminated inflatable chair, an illuminated inflatable shell float, an illuminated inflatable mattress, an illuminated inflatable pool float, an illuminated inflatable hammock, an illuminated inflatable inner tube, an illuminated inflatable cooler, an illuminated inflatable cooler base, an illuminated inflatable drink holder, an illuminated inflatable bar, an illuminated inflatable ball, an illuminated inflatable billiard set, an illuminated inflatable net, an illuminated inflatable beer pong table, an illuminated inflatable ring toss, an illuminated inflatable cornhole game, an illuminated inflatable obstacle course, an illuminated inflatable maze, an illuminated inflatable see-saw, an illuminated inflatable gameboard, an illuminated inflatable surfboard, an illuminated inflatable trampoline, an illuminated inflatable cushion, an illuminated inflatable arch, an illuminated inflatable baby float, an illuminated inflatable life preserver, an illuminated inflatable life vest, an illuminated inflatable climbing wall, an illuminated inflatable buoy, an illuminated inflatable raft, an illuminated inflatable kayak, an illuminated inflatable boat, an illuminated inflatable paddle board, a pair of illuminated inflatable armbands, an illuminated inflatable kite, an illuminated inflatable tent, an illuminated inflatable castle, an illuminated inflatable bounce house, an illuminated inflatable slide, an illuminated inflatable swimming pool, a piece of illuminated inflatable patio furniture, or an illuminated inflatable yard decoration.

12. The illuminated inflatable object of claim 1, wherein the at least one solar panel is comprised of amorphous silicon, an anti-reflection coating, cadmium telluride, a carbon fullerene, copper indium gallium (di)selenide, copper phthalocyanine, copper zinc tin sulfide, copper zinc tin selenide, copper zinc tin sulfide/selenide, dye-sensitized solar cells, fullerene derivatives, gallium arsenide, gallium indium phosphide, germanium, graphene, Grätzel cells, kesterite, lanthanide-doped materials, monocrystalline silicon, multicrystalline silicon, multijunction solar cells, organic solar cells, perovskite solar cells, polycrystalline silicon on glass, polymer solar cells, polyphenylene vinylene, quantum dot solar cells, silicon nitride, thin film solar cells, and/or titanium dioxide.

13. An illuminated inflatable object comprising:
at least two pieces of material, wherein each of the at least two pieces of material has an exterior surface and an interior surface, wherein each of the at least two pieces of material is permanently affixed to at least one other piece of material of the at least two pieces of material, and wherein the at least two pieces of material define at least one interior chamber;
at least one valve for delivering a fluid to and removing the fluid from the at least one interior chamber;
at least one rechargeable battery, wherein the at least one rechargeable battery is disposed in one or more of the at least one interior chamber;
at least one solar panel electrically connected to one or more of the at least one rechargeable battery, wherein the at least one solar panel is disposed in one or more of the at least one interior chamber;
at least one lighting source, wherein the at least one lighting source is disposed in one or more of the at least one interior chamber; and
at least one antenna, wherein the at least one antenna is disposed in one or more of at least one interior chamber;
wherein the at least one interior chamber is constructed and configured to retain the fluid;
wherein the interior surface of each of the at least two pieces of material is comprised of at least one layer of a waterproof material;
wherein the at least one rechargeable battery is operable to power one or more of the at least one lighting source;
wherein the at least one solar panel is operable to recharge one or more of the at least one rechargeable battery; and
wherein the illuminated inflatable object is operable to receive input data from at least one remote device via the at least one antenna.

14. The illuminated inflatable object of claim 13, wherein the at least one remote device wirelessly transmits the input data via Bluetooth, radiofrequency, ZigBee, Wi-Fi, or near field communication.

15. The illuminated inflatable object of claim 13, wherein the at least one remote device a remote control, a smartphone, a tablet, or a laptop computer.

16. The illuminated inflatable object of claim 13, wherein the input data is a color setting, a brightness setting, a lighting type setting, and/or a power setting.

17. An illuminated inflatable chair comprising:
at least two pieces of material, wherein each of the at least two pieces of material has an exterior surface and an interior surface, wherein each of the at least two pieces of material is permanently affixed to at least one other piece of material of the at least two pieces of material, wherein the at least two pieces of material define at least one interior chamber, wherein the at least two pieces of material define a seat part and a back part;
at least one valve for delivering a fluid to and removing the fluid from the at least one interior chamber;
at least one rechargeable battery, wherein the at least one rechargeable battery is disposed in one or more of the at least one interior chamber;
at least one solar panel electrically connected to one or more of the at least one rechargeable battery, wherein the at least one solar panel is disposed in one or more of the at least one interior chamber;
at least one lighting source, wherein the at least one lighting source is disposed in one or more of the at least one interior chamber; and
at least one antenna, wherein the at least one antenna is disposed in one or more of at least one interior chamber;
wherein the at least one interior chamber is constructed and configured to retain the fluid;
wherein the interior surface of each of the at least two pieces of material is comprised of at least one layer of a waterproof material;
wherein the at least one rechargeable battery is operable to power one or more of the at least one lighting source;
wherein the at least one solar panel is operable to recharge one or more of the at least one rechargeable battery; and
wherein the illuminated inflatable chair is operable to receive input data from at least one remote device via the at least one antenna.

18. The illuminated inflatable chair of claim 17, further comprising a pair of armrests defined by the at least two pieces of material.

19. The illuminated inflatable chair of claim 17, further comprising at least one cupholder defined by the at least two pieces of material.

20. The illuminated inflatable chair of claim 20, wherein the at least one remote device wirelessly transmits the input data via Bluetooth, radiofrequency, ZigBee, Wi-Fi, or near field communication.
